(19) United States
(12) Patent Application Publication
(10) Pub. No.: US 2015/0033356 A1
(43) Pub. Date: Jan. 29, 2015

(54) ANONYMIZATION DEVICE, ANONYMIZATION METHOD AND COMPUTER READABLE MEDIUM

(71) Applicant: Takao Takenouchi, Tokyo (JP)

(72) Inventor: Takao Takenouchi, Tokyo (JP)

(73) Assignee: NEC CORPORATION, Tokyo (JP)

(21) Appl. No.: 14/378,849

(22) PCT Filed: Feb. 6, 2013
(86) PCT No.: PCT/JP2013/000639

§ 371 Date: Aug. 14, 2014

(30) Foreign Application Priority Data
Feb. 17, 2012 (JP) 2012-032992

(51) Int. Cl. G06F 21/62

(52) U.S. Cl. CPC G06F 21/6254
USPC 726/26

(57) ABSTRACT

The present invention preserves the anonymity of data even against the providers of the data. This anonymization device contains: a determination unit for determining whether or not the anonymity of data linked with records acquired from multiple providers is preserved against the providers that provided the records which are a part of the data; and an anonymization unit for anonymizing the data on the basis of the anonymity determination result of the determination unit.

### FIELD OF THE INVENTION

The present invention relates to an anonymization technology.

### BACKGROUND OF THE INVENTION

Statistical data relating to data including personal information, such as age, gender or address is utilized. There have been known Technologies for anonymizing the data by using data abstraction so that individuals are not specified from disclosed data when the data is disclosed is known. The anonymization is a technology which processes data so as not to specify whose individual data is each record in a set of personal information. There is “k-anonymity” as an index of anonymization. The k-anonymity is anonymization which guarantees that data which are same as the each individual data are not narrowed down less than k number. A group of attributes which can specify an individual based on a combination of them in attributes included in personal information is called a “quasi-identifier”. Basically, the k-anonymity guarantees anonymity on a basis of generalizing attribute values included in these quasi-identifiers and making the number of records which jointly have a quasi-identifier larger than or equal to k.

For example, in patent literature 1, an information processing device which can judge anonymity as a whole of the items based on a comparison between a minimum value and a threshold value when grouping at each item of collected data is disclosed.

In the information processing device disclosed in patent literature 1, an anonymization item storage unit stores anonymization classifiers for each item.

An anonymization processing unit designates the anonymization classifier for each item to data recorded in a first database. Then, the anonymization processing unit groups the data on the basis of the anonymization classifiers. Then, the anonymization processing unit calculates a minimum number of data after grouping for each item, and anonymization on the basis of the result of the calculation. Then, the anonymization processing unit records the result of the anonymization process in a second database.

An anonymization judgment unit judges whether or not there exists an item for which the number of data is less than a predetermined threshold value to the result of the anonymization process recorded in the second database.

### PRIOR ART LITERATURE

### Patent Literature

[Patent Literature 1] Japanese Patent Application Publication Laid-Open No. 2010-086179

### SUMMARY OF THE INVENTION

### Problems to be Solved by the Invention

However, the technology disclosed in patent literature 1 has a possibility that personal information which other provision source provides can be specified on a basis of a comparison between data existing in an provision sources of information and anonymized data. That is, the technology disclosed in patent literature 1 has a problem that anonymity is not always preserved.

The reason of this is as follows. A provision source of data can specify self-provided data in anonymized data. Accordingly, provision sources of data can make the anonymity of data of other provision sources lower than a predetermined index by removing the self-provided data which is specified.

One of objects of the present invention is to provide an anonymization device and an anonymization method which can preserve the anonymity of the data to any one of provision sources which provide data.

### Means for Solving the Problem

To achieve the above-mentioned object, an anonymization device according to the present invention includes: judgment unit for judging whether or not anonymity of data is preserved to any one of providers which provide a record which is a part of the data for data which is combined with records acquired from plural providers; and anonymization unit for anonymizing the data on the basis of a judgment result of anonymity of said judgment unit.

To achieve the above-mentioned object, an anonymization method according to the present invention includes: judging whether or not anonymity of data is preserved to any one of providers which provide a record which is a part of the data for data which is combined with records acquired from plural providers; and anonymizing the data on the basis of the judgment result.

To achieve the above-mentioned object, a program according to the present invention causes a computer to execute: processing for judging whether or not anonymity of data is preserved to any one of providers which provide a record which is a part of the data for data which is combined with records acquired from plural providers; and a processing for anonymizing the data on the basis of the judgment result.

### Effect of the Invention

An example of effects of the present invention can preserve the anonymity of the data to any one of provision resources which provide data.

### BRIEF DESCRIPTION OF THE DRAWINGS

FIG. 1 is a diagram for describing a background of the present invention.

FIG. 2 is a diagram showing data which Hospital X holds.

FIG. 3 is a diagram showing data which Hospital Y holds.

FIG. 4 is a diagram showing data which Provider Z holds.

FIG. 5 is a diagram showing a state where the data shown in

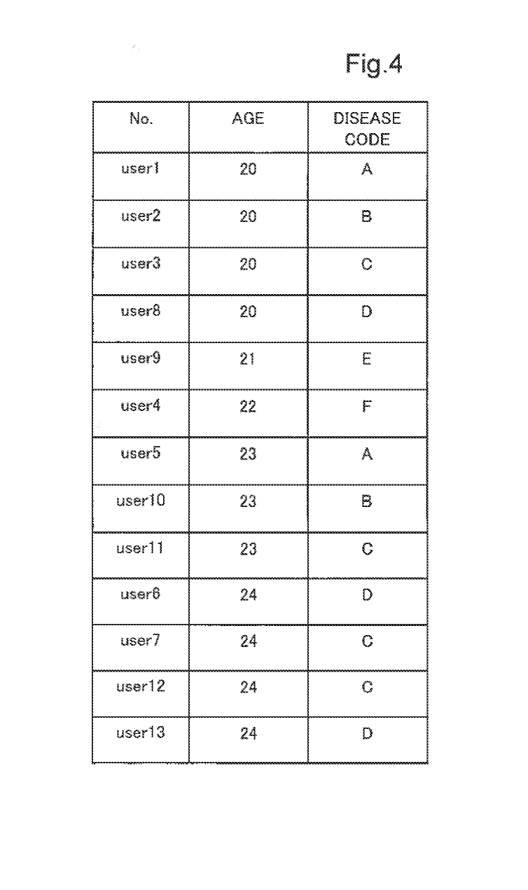

FIG. 4 is divided into plural groups on the basis of an anonymization technology related to the present invention.

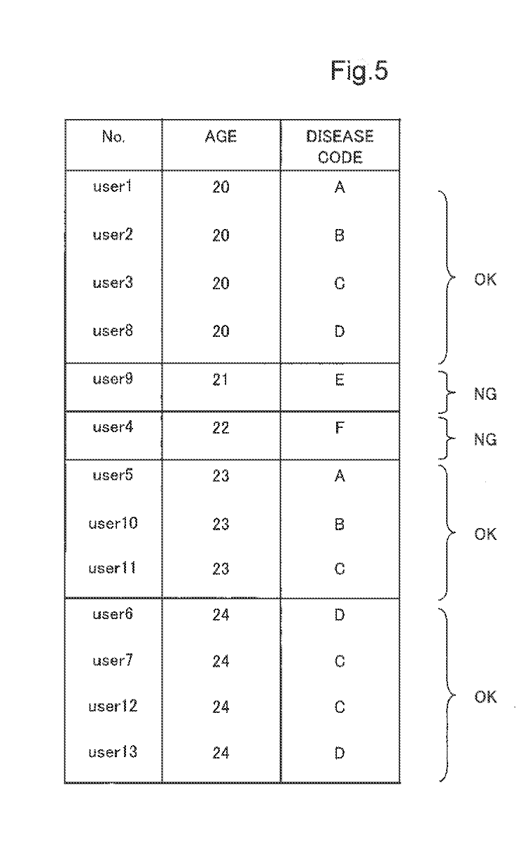

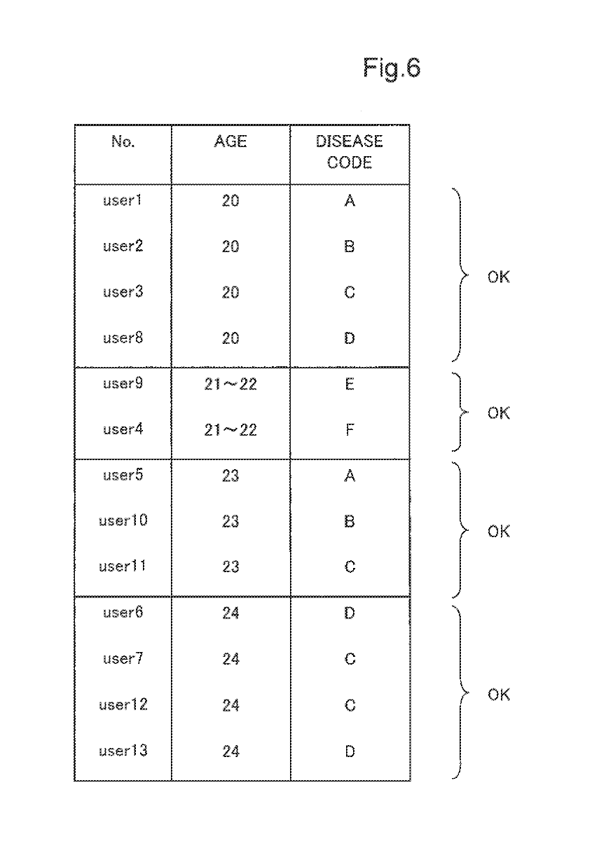

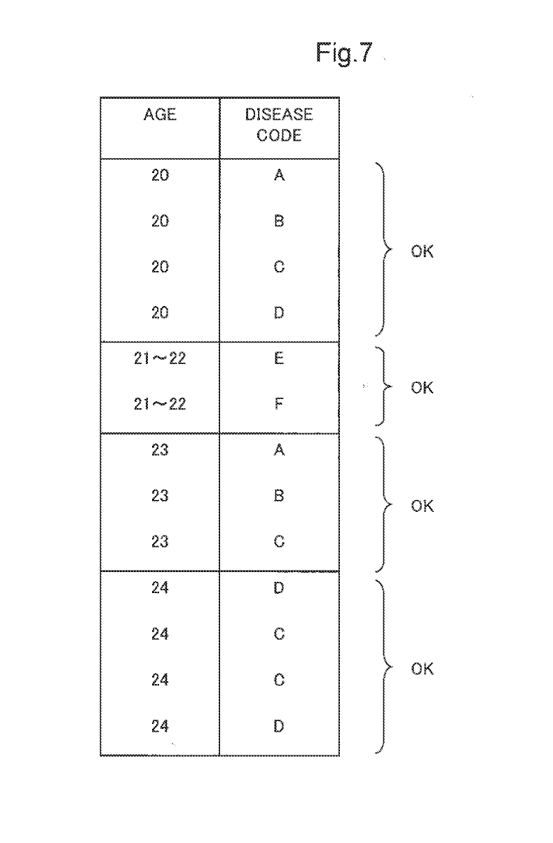

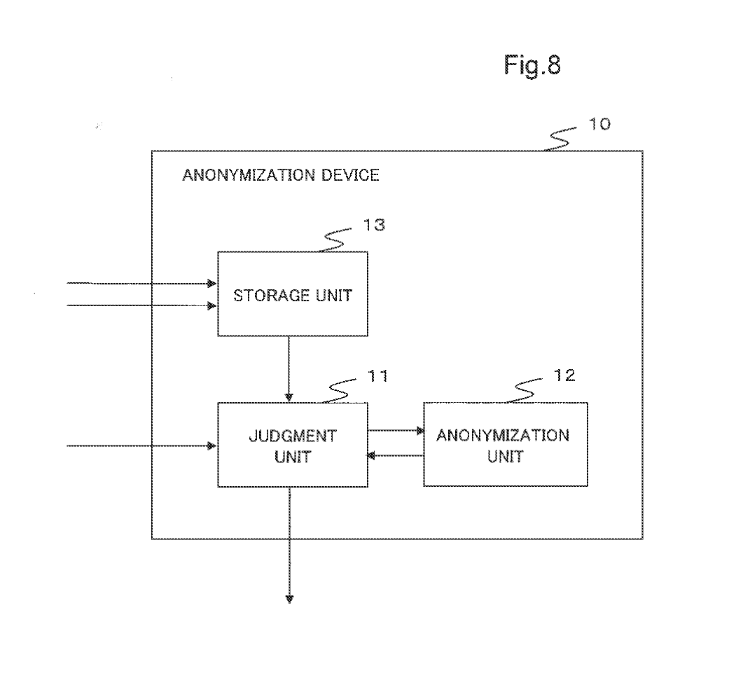

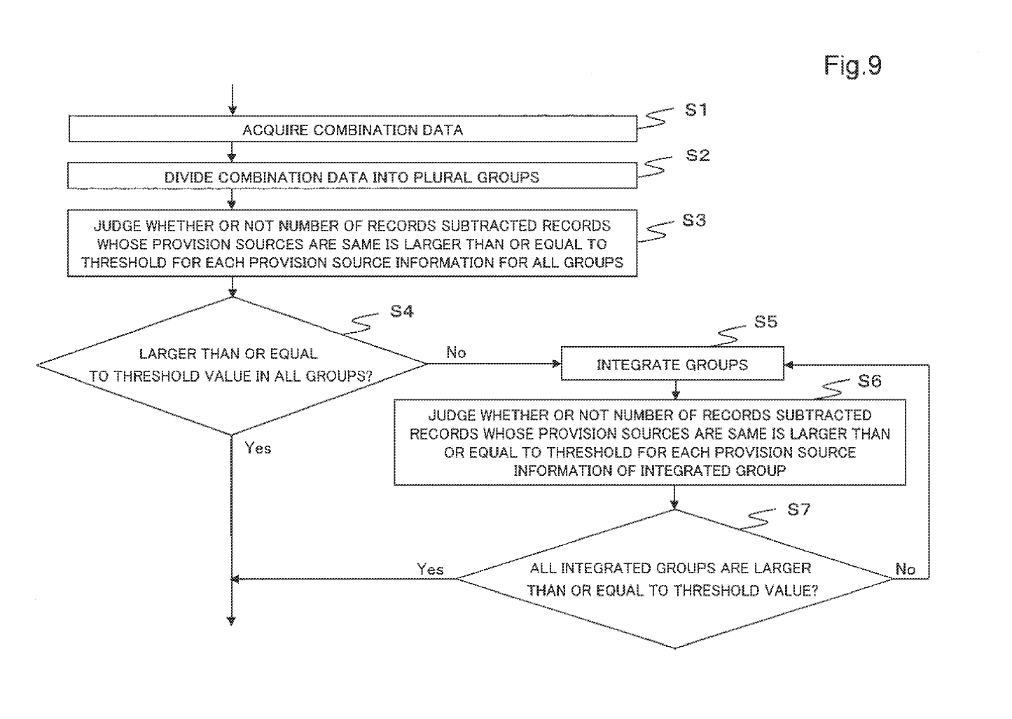

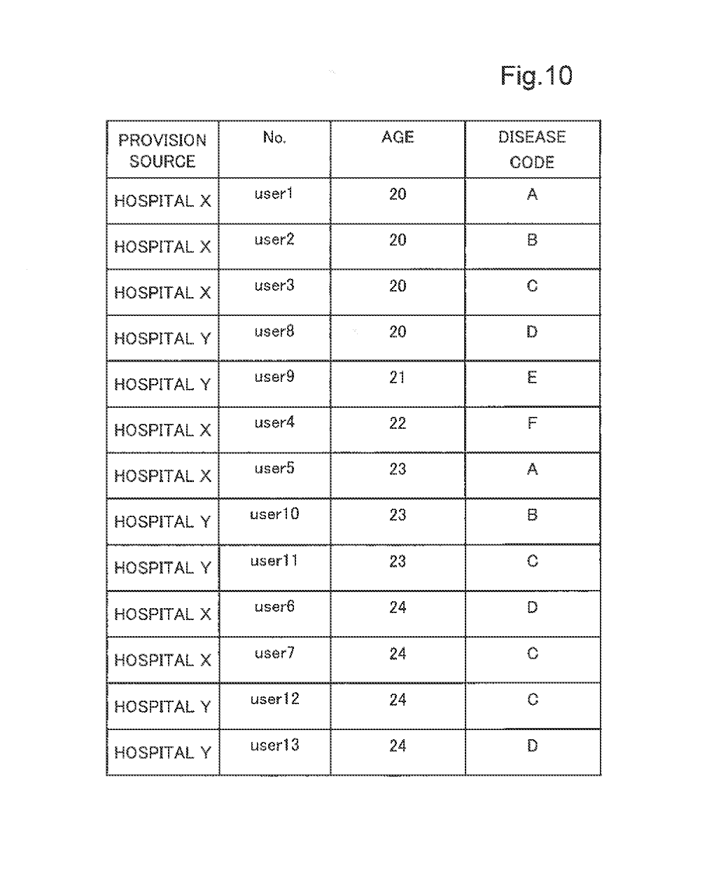

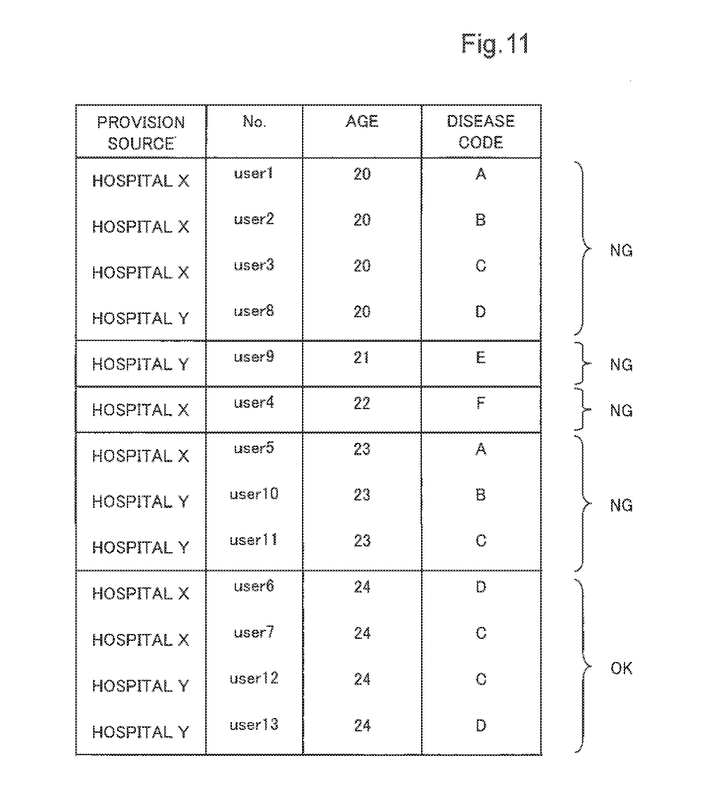

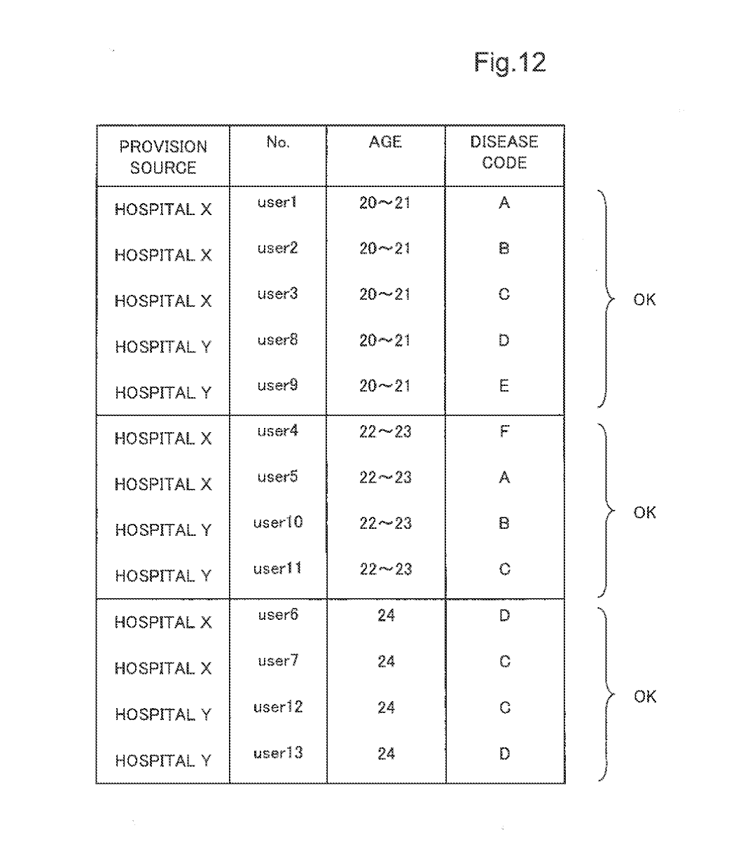

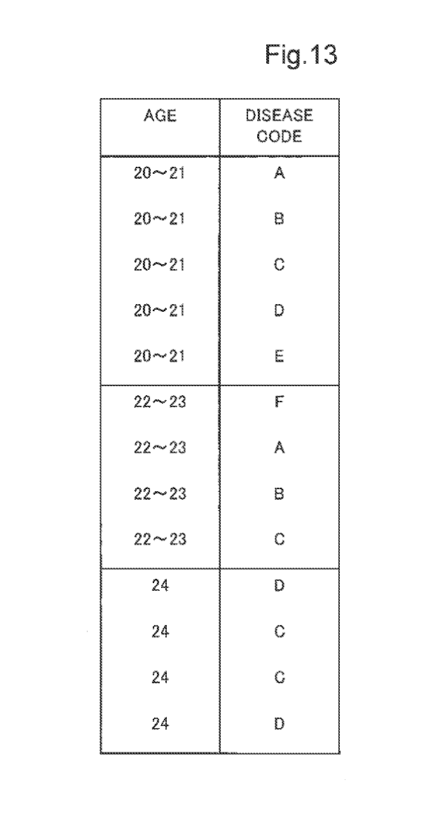

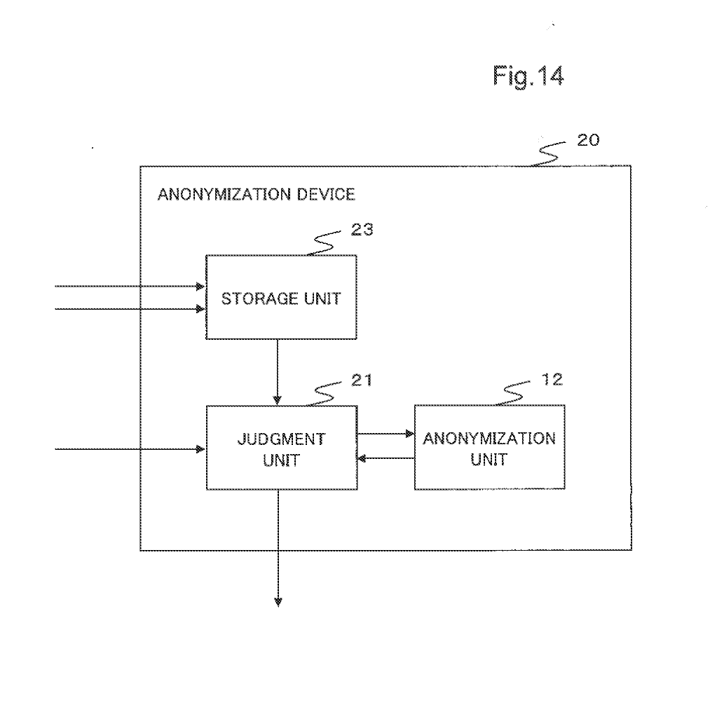

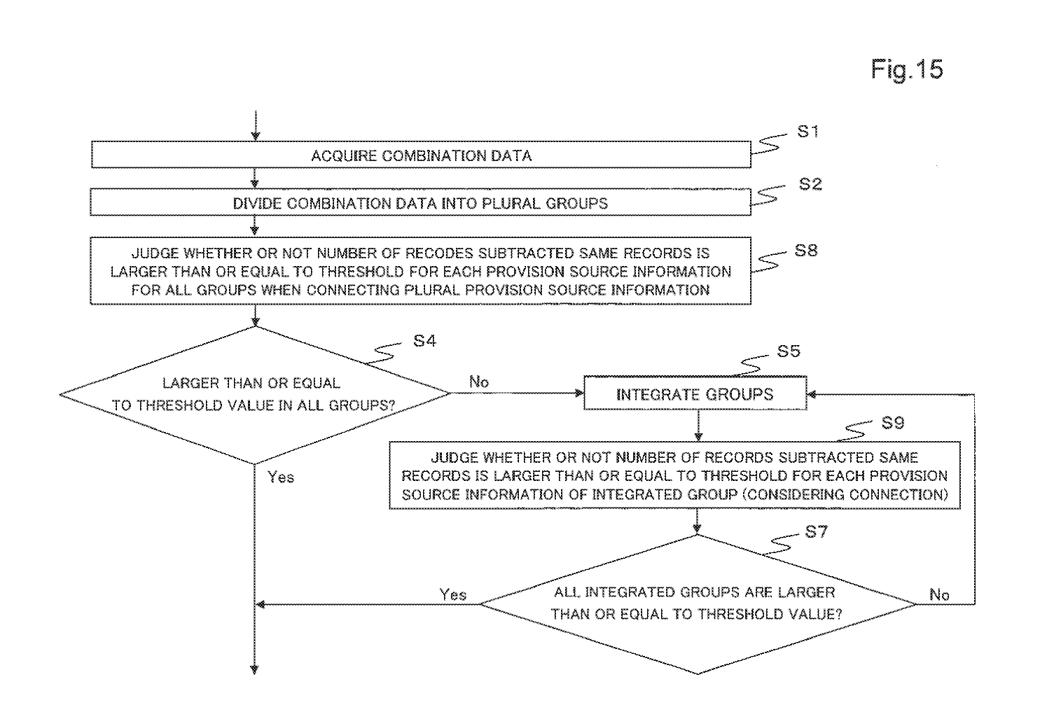

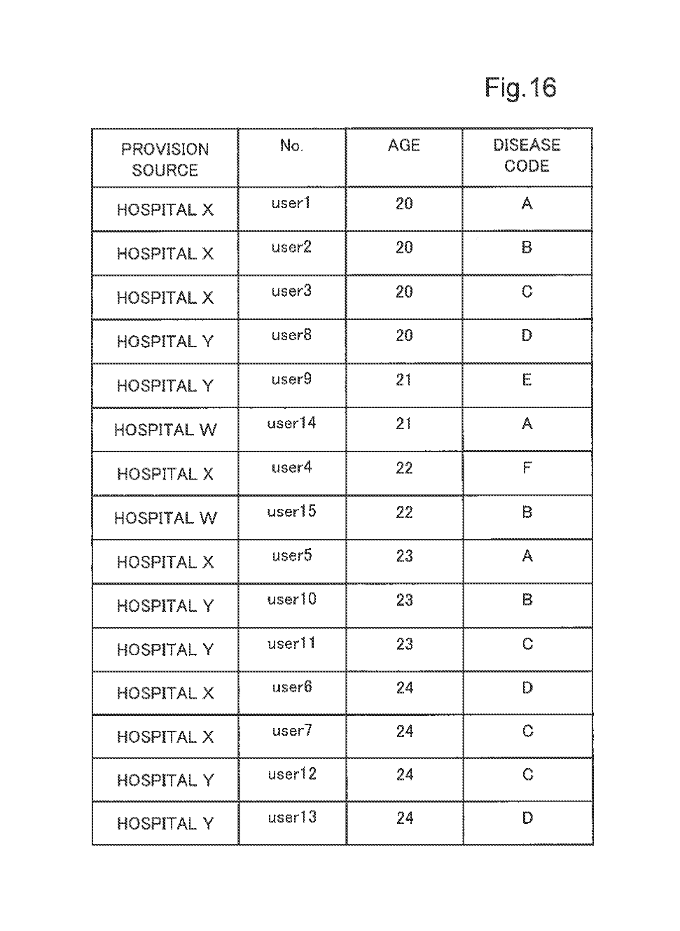

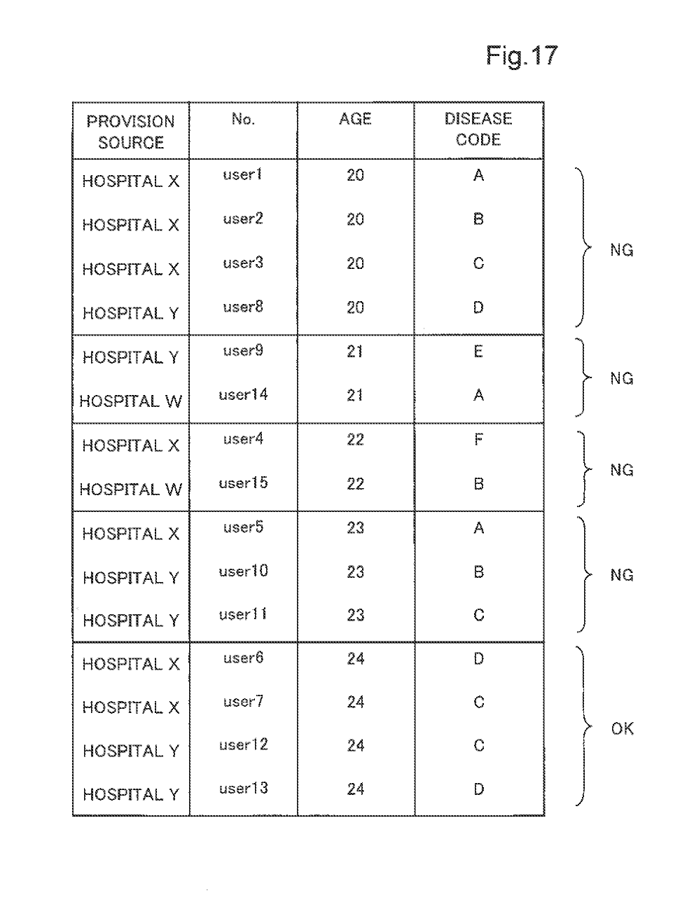

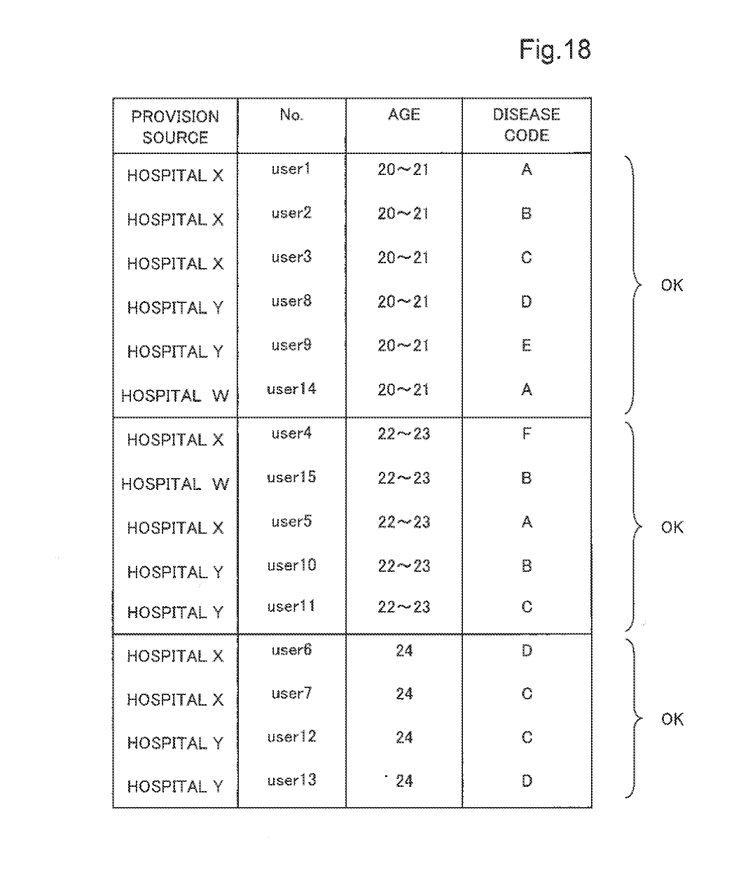

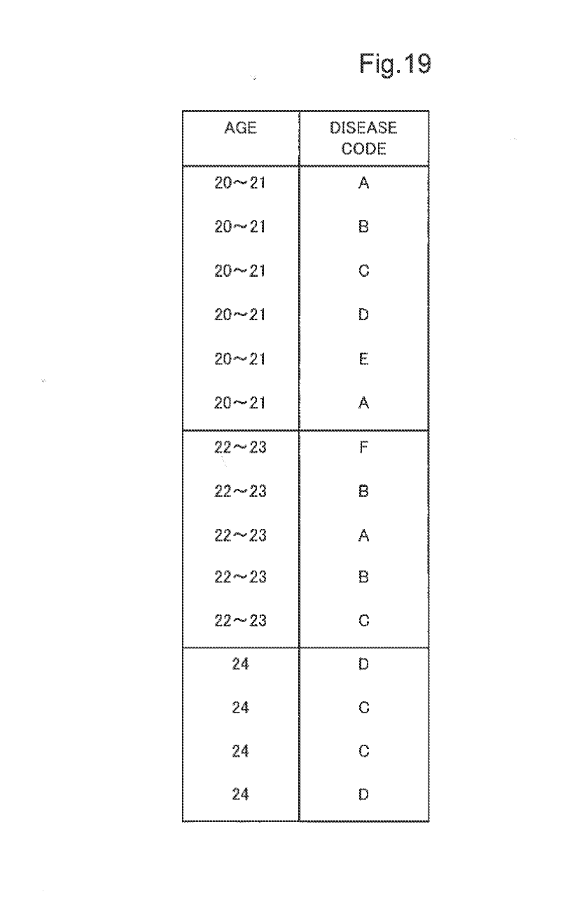

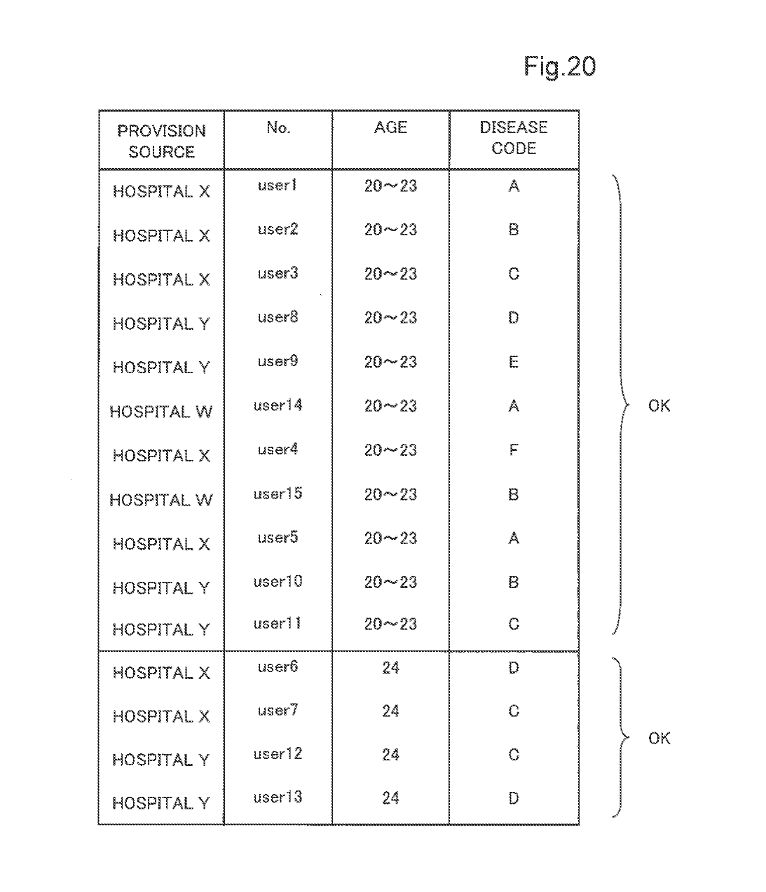

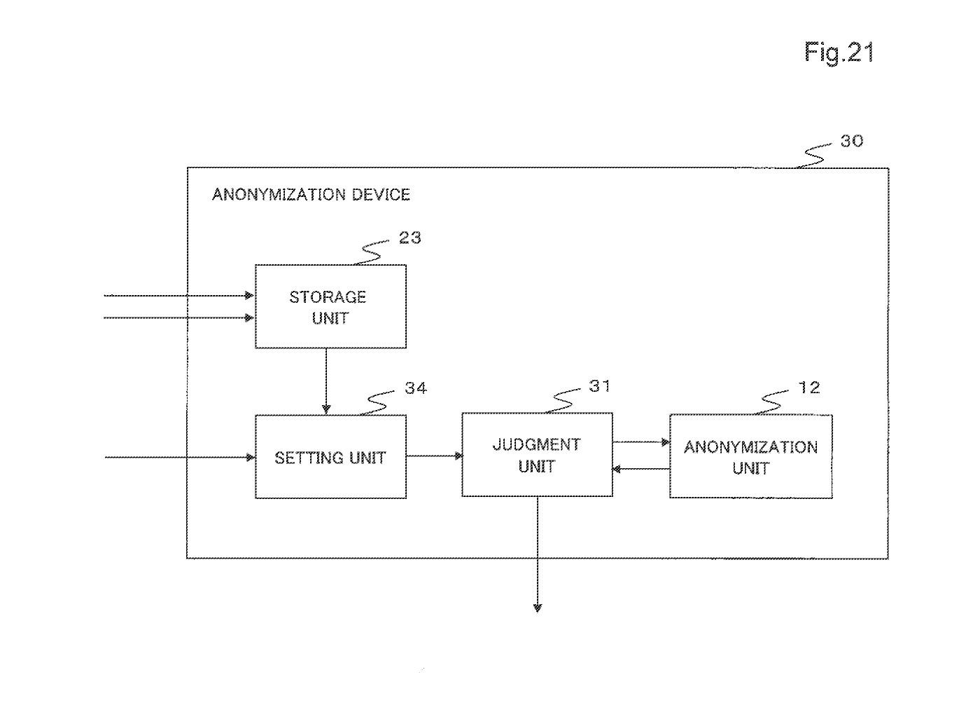

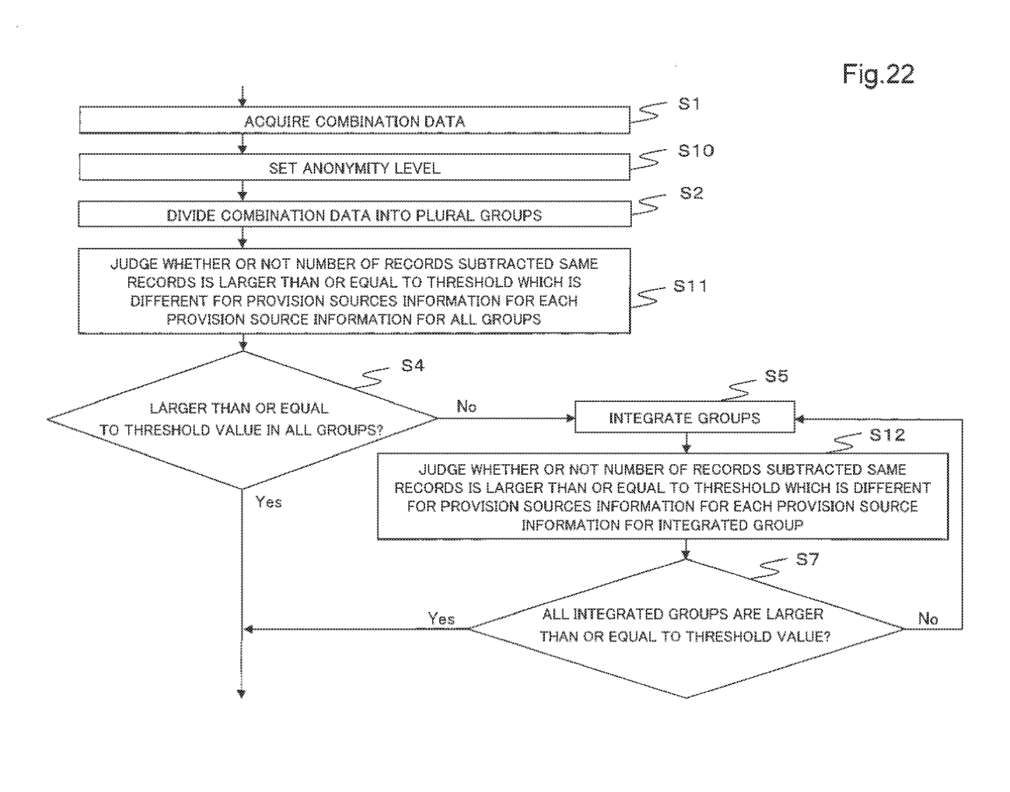

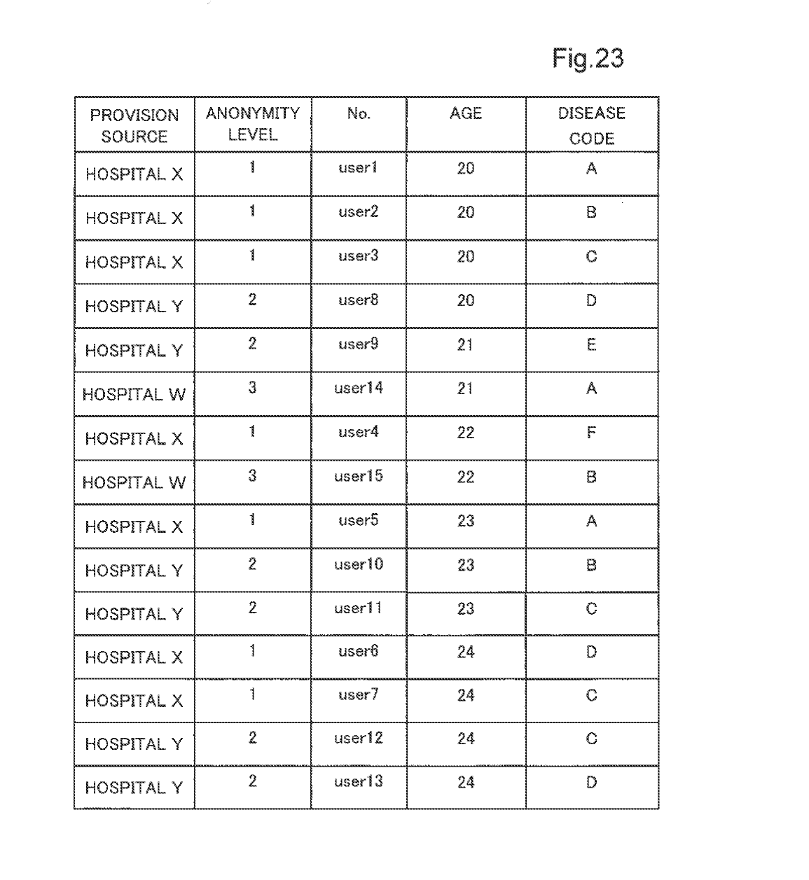

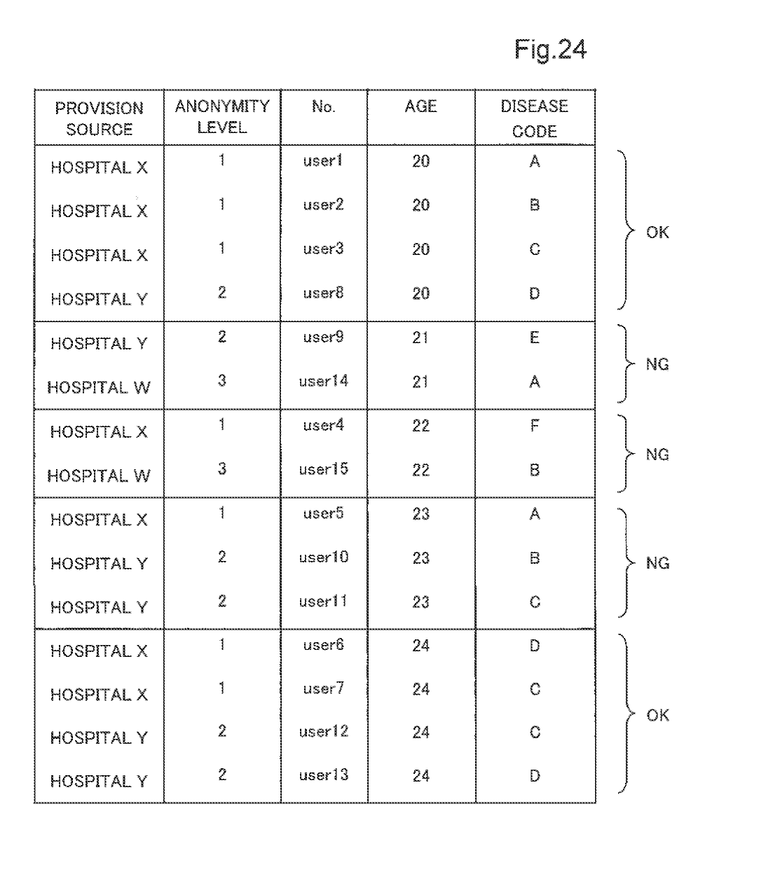

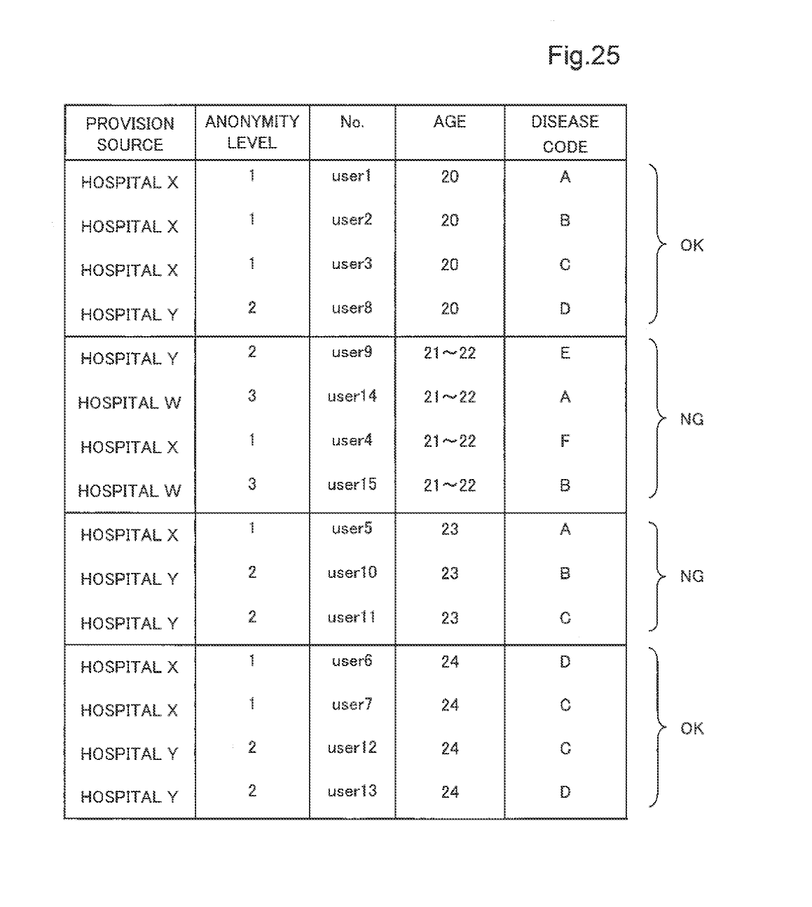

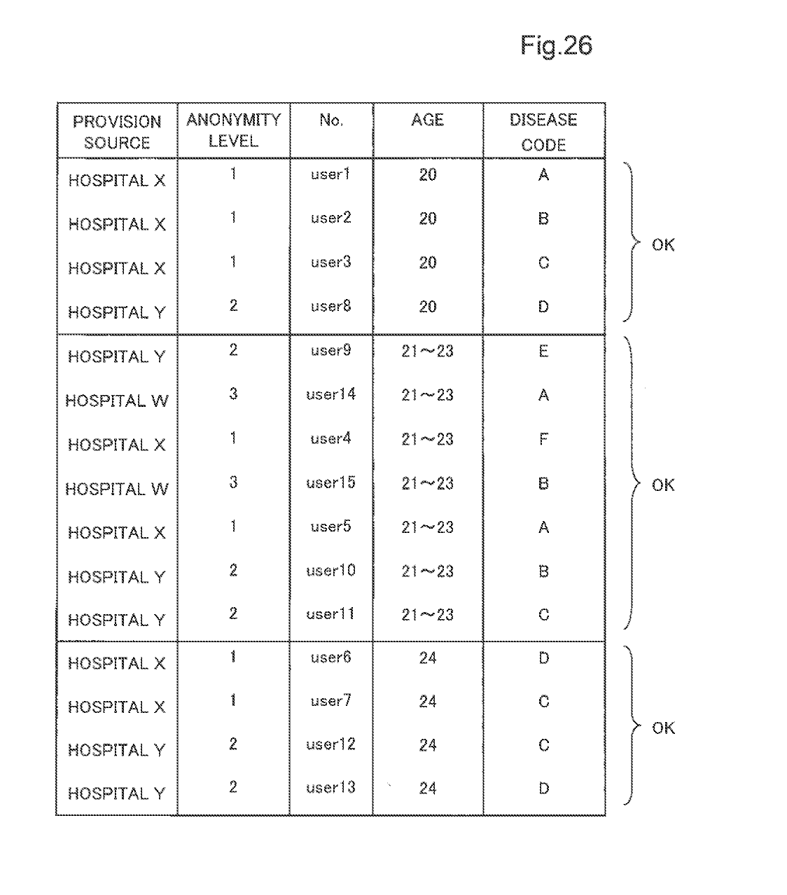

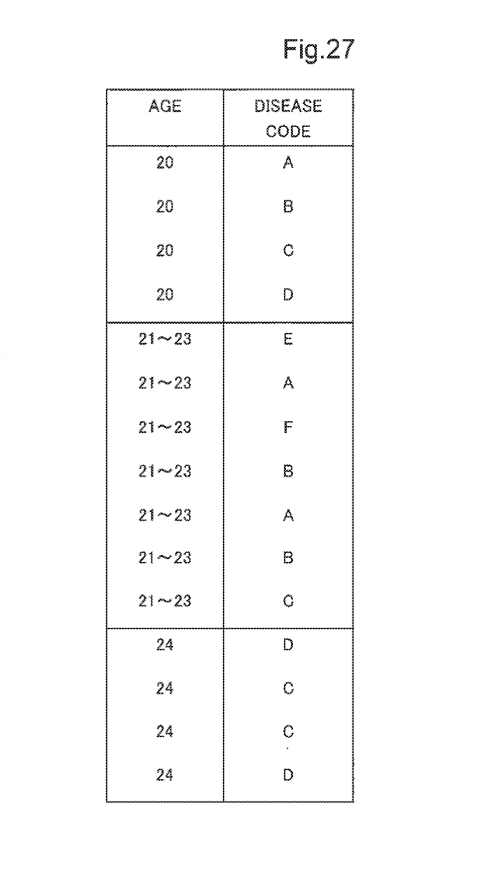

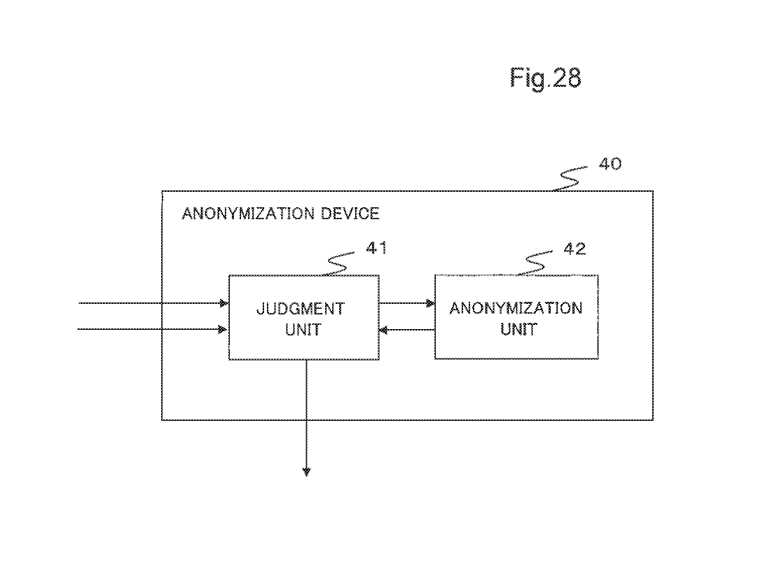

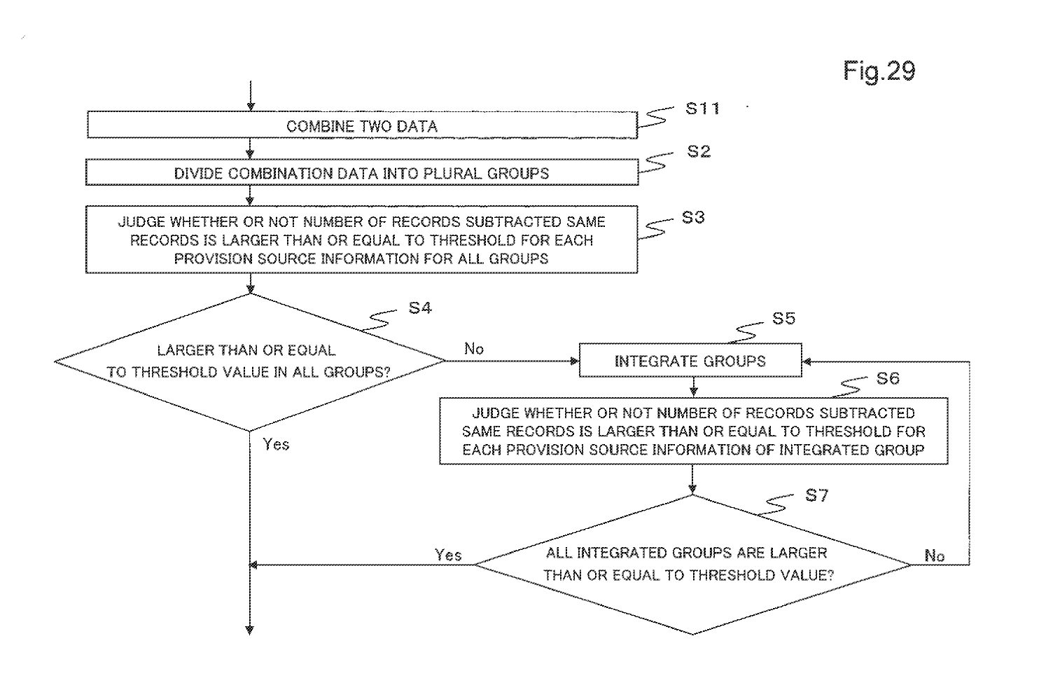

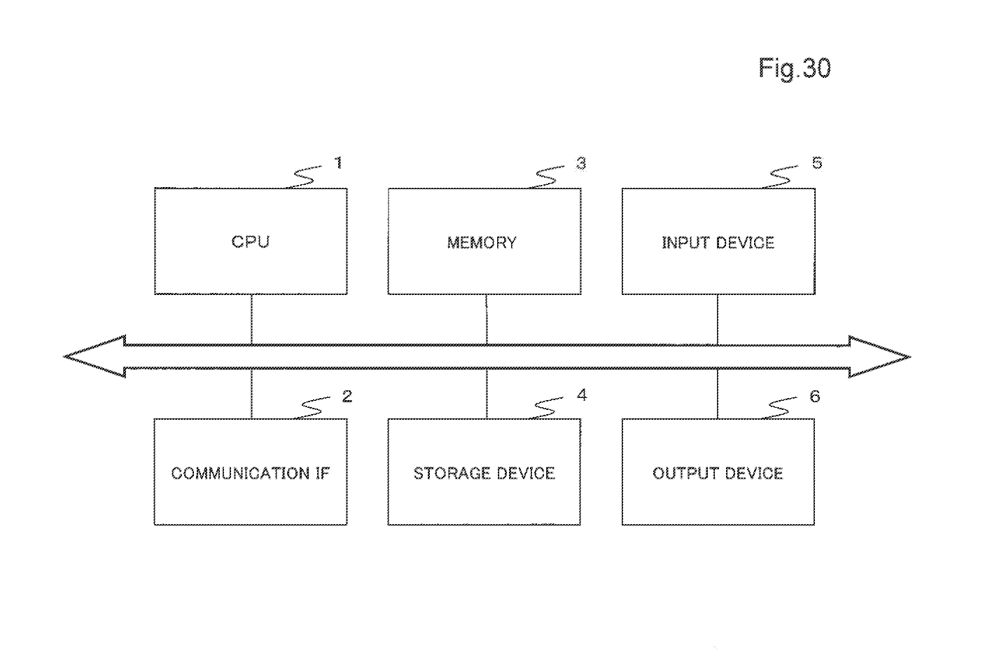

FIG. 6 is a diagram showing data integrated a part of the data shown in FIG. 5.

FIG. 7 is a diagram showing anonymized combination data finally generated on a basis of an anonymization technology related to the present invention.

FIG. 8 is a block diagram showing a configuration of an anonymization device 10 according to a first exemplary embodiment.

FIG. 9 is a flowchart showing operation of the anonymization device 10 according to the first exemplary embodiment of the present invention.

FIG. 10 is a diagram showing an example of combination data which a storage unit 13 stores.

FIG. 11 is a diagram showing an example of combination data divided into plural groups on a basis of value of a quasi-identifier.

FIG. 12 is a diagram showing an example of data after an anonymization unit 12 anonymizes.

FIG. 13 is a diagram showing an example of anonymized combination data which the anonymization device 10 finally outputs.

FIG. 14 is a block diagram showing a configuration of an anonymization device 20 according to a second exemplary embodiment.

FIG. 15 is a flowchart showing operation of the anonymization device 20 according to the second exemplary embodiment of the present invention.

FIG. 16 is a diagram showing an example of combination data which is appended provision source information of three types of “Hospital X”, “Hospital Y” and “Hospital W”.

FIG. 17 is a diagram showing an example of a state where divided into plural groups on the basis of value of the data quasi-identifier shown in FIG. 16.

FIG. 18 is a diagram showing an example of a state integrated the data shown in FIG. 17.

FIG. 19 is a diagram showing an example of anonymized combination data which the anonymization device 20 finally output.

FIG. 20 is a diagram showing anonymized data in the case of considering a conspiracy of provision sources in a different variation.

FIG. 21 is a block diagram showing a configuration of an anonymization device 20 according to a third exemplary embodiment.

FIG. 22 is a flowchart showing operation of the anonymization device 30 according to the third exemplary embodiment of the present invention.

FIG. 23 is a diagram showing an example of combination data which is set threshold values of anonymity levels which are different for each types of provision source information.

FIG. 24 is a diagram showing an example of a state where the data shown in FIG. 23 is divided into plural groups on the basis of values of a quasi-identifier.

FIG. 25 is a diagram showing an example of a state where the data shown in FIG. 24 is integrated.

FIG. 26 is a diagram showing an example of a state where the data shown in FIG. 25 is integrated.

FIG. 27 is a diagram showing an example of anonymized combination data which the anonymization device 30 finally outputs.

FIG. 28 is a block diagram showing a configuration of an anonymization device 40 according to a fourth exemplary embodiment.

FIG. 29 is a flowchart showing operation of the anonymization device 40 according to the fourth exemplary embodiment of the present invention.

FIG. 30 is a block diagram showing an example of hardware configuration of the anonymization device 10 according to the first exemplary embodiment.

### EXEMPLARY EMBODIMENT OF THE INVENTION

### First Exemplary Embodiment

First, in order to easily understand exemplary embodiments of the present invention, a background of the present invention will be described.

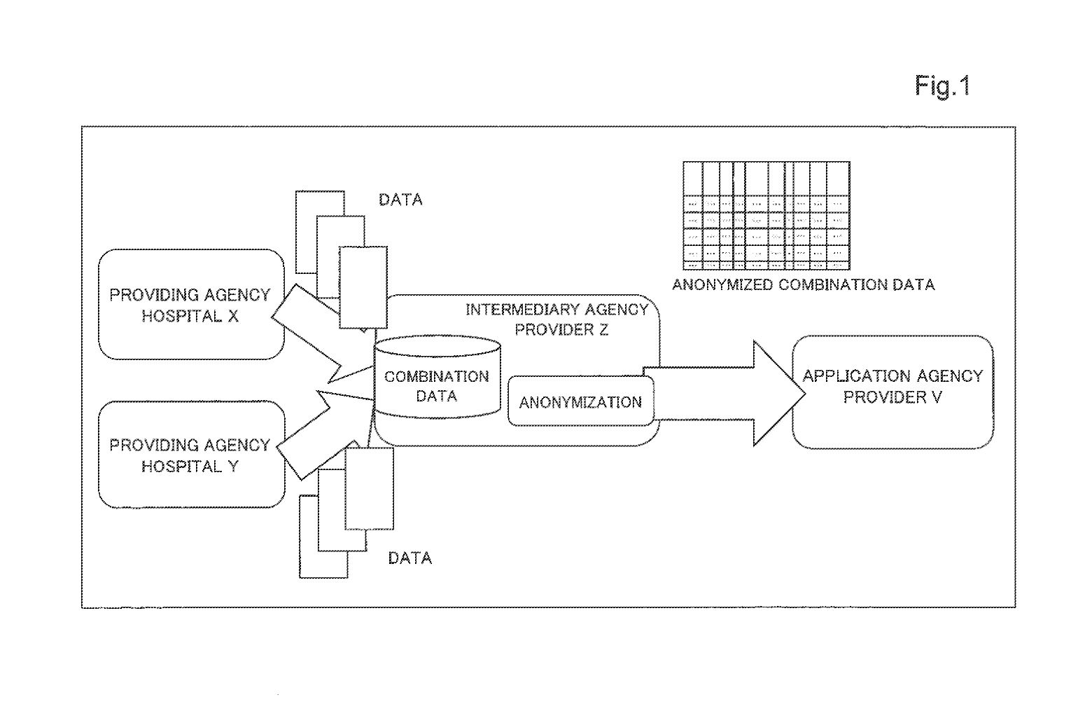

FIG. 1 is a diagram for describing a background of the present invention.

As shown in FIG. 1, as the background of the present invention, it is supposed a scene in which Provider Z which is an intermediary agency is provided data from Hospital X and Hospital Y which are provision agencies of data, combines the data, and provides it to Provider V which is an application agency of data. In this scene, Provider Z which is provided the two data secures anonymity of individual of the combination data by combining both data and performing an anonymization process.

Generally, data targeted for an anonymization process includes ID (Identification) which identifies a user, sensitive information and a quasi-identifier.

The sensitive information is information which is not preferred to be known to others in the state of being associated with an individual.

The quasi-identifier is information which can not specify an individual in the state of single information, but has a possibility of a specification of an individual on a basis of combination with other information.

It is preferable that a value of the quasi-identifier is abstracted in a unified manner in entire records in the meaning of preventing specification of an individual. On the other hand, it is preferable that a value of the quasi-identifier is respectively concrete from the viewpoint of using combination data.

The anonymization process is a process of harmonizing the purpose of “preventing specification of an individual” and the purpose of “using combination data”. In anonymization processes, there are a top-down process and a bottom-up process. Here, the anonymization process of top-down process is “a process of dividing data”, and the anonymization process of bottom-up process is “a process of integrating data”.

Hereinafter, the background will be described more concretely.

Provider Z collects personal information which two different hospitals as Hospital X and Hospital Y respectively hold, and combines both data with preserving the anonymity.

Here, as an example of description, it is supposed that the personal information held by Hospital X and Hospital Y is information including “No.”, “age” and “disease code”.

The “No.” corresponds to an ID of each user.

Then, it is supposed that the “disease code” by which a specification of an individual's disease is sensitive information. And, the sensitive information is information which is not preferred to be changed in an abstraction process because it is used in an analysis of disclosed data.

Then, the abstraction process is a process of converting an attribute or an attribute value of data into data of an attribute or an attribute value with a wider range. Here, for example, the attribute is a classification of age, gender, address or so on. And, the attribute value is a concrete content or a value of an attribute. In the case where abstraction target data is a concrete value, a process which converts the value into numerical-value range data including the value (ambiguous data) is an example of the abstraction process.

It is supposed that personal information other than the sensitive information is a quasi-identifier. Here, the “age” is a quasi-identifier.

An anonymization technology in relation to the present invention judges whether or not anonymity is preserved on the basis of whether or not a predetermined index of k-anonymity is satisfied. The k-anonymity is an index which requires k or more data whose quasi-identifiers are same values. In description below, it is supposed that 2-anonymity is required. And, it is supposed that an anonymization process uses the bottom-up process.

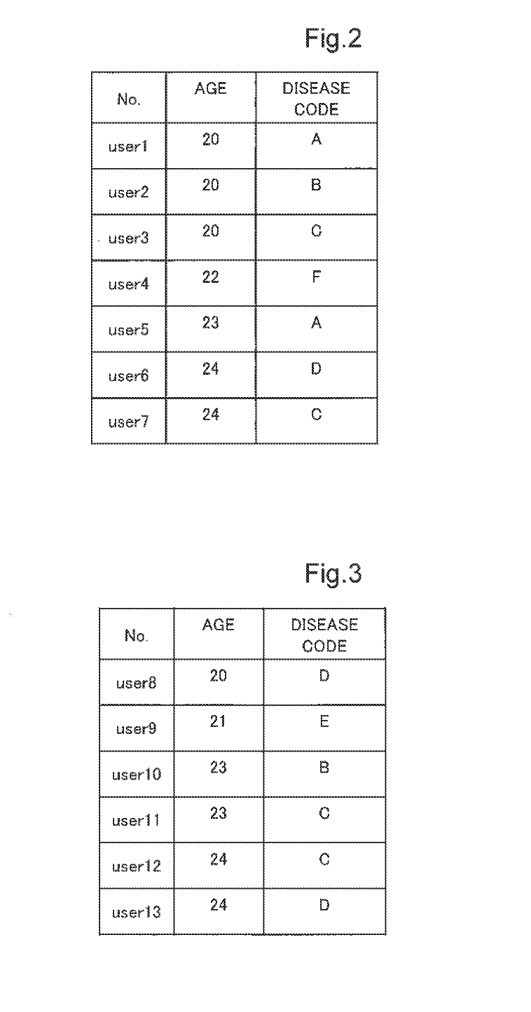

FIG. 2 is a diagram showing data which Hospital X holds. As shown in FIG. 2, Hospital X holds personal information of seven persons whose user IDs are user 1 to user 7 totally.

FIG. 3 is a diagram showing data which Hospital Y holds. As shown in FIG. 3, Hospital Y holds personal information of six persons whose user IDs are user 8 to user 13.

FIG. 4 is a diagram showing data which Provider Z holds. As shown in FIG. 4, Provider Z acquires the data shown in FIG. 2 from Hospital X and the data shown in FIG. 3 from Hospital Y, combines both data, and holds it. Data shown in FIG. 4 is arranged in age order.

Next, anonymization based on an anonymization technology in relation to the present invention will be described.

The anonymization technology in relation to the present invention divides the combination data shown in FIG. 4 into plural groups on the basis of “age” which is a quasi-identifier.

FIG. 5 is a diagram showing a state where the data shown in FIG. 4 is divided into plural groups on the basis of the anonymization technology related to the present invention. In FIG. 5, because the group whose “age” is “20” includes four users {user 1, user 2, user 3 and user 8}, it satisfies 2-anonymity. Similarly, groups whose “age”s are “23” and “24” satisfy 2-anonymity. However, because groups whose “age”s are “21” and “22” have one included user so as {user 9} and {user 4} respectively, they do not satisfy 2-anonymity. Therefore, the anonymization technology of bottom-up in relation to the present invention, for example, integrates the group whose “age” is “21” and the group whose “age” is “22”.

FIG. 6 is a diagram showing data integrated a part of the data shown in FIG. 5. As shown in FIG. 6, the group whose “age” is “21” and the group whose “age” is “22” are integrated into the group whose “age” is “21-22”. This integrated group satisfies 2-anonymity.

FIG. 7 is a diagram showing anonymized combination data which is finally generated on a basis of the anonymization technology related to the present invention. As shown in FIG. 7, the anonymization technology in relation to the present invention anonymizes data which Provider Z stores so that all groups satisfy 2-anonymity.

However, there is a case where the provision source of the data can specify personal information existing in other provision source on the basis of comparison of data existing in the provision source of information with anonymized data. That is, there is a case where it cannot necessarily be said that the anonymity of the data shown in FIG. 7 is preserved.

A reason for this is as follows.

The provider of data provision source (Hospital X and Hospital Y) which provides data can specify the data provided by itself in anonymized data. For this reason, the provision source of data can make the anonymity of the data lower than a predetermined index.

More concrete description is as follows.

For example, Hospital X compares the data which is shown in FIG. 2 and provided by itself with the anonymized combination data shown in FIG. 7. Then, Hospital X can specify that data corresponding to a user whose “disease code” is “F” is the data provided by itself in data belonging to the group whose “age” is “21-22” based on the comparison. Similarly, Hospital Y can also specify data. For this reason, the group whose “age” is “21-22” shown in FIG. 7 does not satisfy 2-anonymity to Hospital X and Hospital Y. Therefore, for example, when Hospital X finds out the “No.” of a user whose “age” is “21” (here, “user 9”) included in the data of Hospital Y, Hospital X can specify that a “disease code” of the “user 9” is “E” on the basis of the anonymized combination data.

In this way, the anonymization technology in relation to the present invention has a problem that it does not satisfy an anonymization index.

A first exemplary embodiment of the present invention which will be described below solves the above-mentioned problem.

The first exemplary embodiment of the present invention will be described with reference to drawings.

First, a functional configuration of an anonymization device 10 according to the first exemplary embodiment of the present invention will be described with reference to FIG. 8.

FIG. 8 is a block diagram showing an example of a configuration of the anonymization device 10 according to the first exemplary embodiment. The anonymization device 10 is, for example, the device which Provider Z shown in FIG. 1 holds.

As shown in FIG. 8, the anonymization device 10 includes a judgment unit 11, an anonymization unit 12 and a storage unit 13.

In addition, in description of this exemplary embodiment, as having been shown in FIG. 1, it is supposed that provision sources of information acquired by the anonymization device 10 are, for example, two with Hospital X and Hospital Y. However, this is an example, and the number of provision sources is not limited to two, but may be three or more.

And, an anonymization process performed by the anonymization unit 12 which the anonymization device 10 includes may be an existing method, and may be a top-down process or a bottom-up process. Therefore, in the following description of this exemplary embodiment, for example, it will be described on the assumption that the anonymization unit 12 performs an anonymization process of a bottom-up process.

The anonymization device 10 stores combination data in the storage unit 13 in advance. The combination data is data combining data which the anonymization device 10 acquires from plural provision sources. The combination data is a set of records in which user attribute information, which is attribute information relating to the user is associated with provision source information which is information indicating the provision source of the user attribute information. For example, as shown in FIG. 8, the anonymization device 10 stores the combination data which is a combination of data acquired from Hospital X and Hospital Y into the storage unit 13.

For example, the anonymization device 10 receives an instruction from a user of the anonymization device 10 and starts anonymization of the combination data. In addition, the anonymization device 10 may be in a mode in which the user instructs a start of anonymization proves to the judgment unit 11 of the anonymization device 10.

The judgment unit 11 acquires the combination data from the storage unit 13 when receiving the start instruction from the user.

The judgment unit 11 judges whether or not the anonymity of data is preserved for any one of provision sources of the data to the combination data acquired from the storage unit 13. In this description, “any one of provision sources” indicates Hospital X and Hospital Y. Therefore, concretely, the judgment unit 11 judges whether or not the anonymity is preserved even when Hospital X and Hospital Y compare data held by itself with the combination data. In addition, as will be described below, the judgment unit 11 judges whether or not the anonymity of the data is preserved even when it is viewed from any one of provision sources of the data for data outputted from the anonymization unit 12,.

When the judgment unit 11 judges that there exists a group in which anonymity is not preserved (for example, k-anonymity is not satisfied), it outputs the combination data to the anonymization unit 12.

The anonymization unit 12 anonymizes the group in which the anonymity included in the received combination data is not preserved when receiving the combination data from the judgment unit 11. Because the anonymization process of this exemplary embodiment is a bottom-up process, the anonymization unit 12 integrates the group in which the anonymity included in the combination data is not preserved.

When there exists a group in which the anonymity is not preserved in the combination data which the anonymization unit 12 anonymized, the judgment unit 11 outputs the combination data to the anonymization unit 12. The anonymization unit 12 receives the combination data and anonymizes it. That is, the judgment unit 11 and the anonymization unit 12 repeat the anonymization process of the anonymization unit 12 until the judgment unit 11 judges that there is no group in which the anonymity is preserved.

When the judgment unit 11 judges that the anonymity of all groups of the combination data is preserved, it outputs the anonymized combination data to outside. The outside is, for example, Provider V shown in FIG. 1. That is, the judgment unit 11 outputs the anonymized combination data, for example, to Provider V shown in FIG. 1.

Next, operation of the anonymization device 10 according to the first exemplary embodiment will be described with reference to FIG. 9.

FIG. 9 is a flowchart showing operation of the anonymization device 10 according to the first exemplary embodiment.

As shown in FIG. 9, the judgment unit 11 of the anonymization device 10 acquires the combination data, to which provision source information is appended from the storage unit 13 (step S1). In addition, the storage unit 13 stores data acquired from plural different providers (for example, Hospital X and Hospital Y) together with information indicating the provision sources (information which indicates whether to be acquired from Hospital X, to be acquired from Hospital Y or the like) in advance.

The judgment unit 11 divides the acquired combination data into plural groups such that plural records which have the same quasi-identifier value are grouped into one group (step S2).

The judgment unit 11 judges whether or not the anonymity of the data is preserved for the combination data acquired from the storage unit 13 to any one of provision sources of data (for example, “Hospital X” and “Hospital Y”) (step S3).

More concretely, the judgment unit 11 judges as follows.

The judgment unit 11 selects one group from groups whose values of quasi-identifier (for example, “age”) are the same, and supposes a group which is removed records including one type of provision source information (for example “Hospital X”). Then, the judgment unit 11 judges whether or not the number of records included in the group is larger than or equal to a threshold value (for example, larger than or equal to two) which is an index of anonymity (for example, “2 anonymity”).

The judgment unit 11 performs similar judgments for all groups.

Moreover, the judgment unit 11 performs similar judgments for all types (for example, “Hospital X” and “Hospital Y”) of provision source information.

Then, the judgment unit 11 judges whether or not the anonymity of the combination data is preserved on the basis of all judgments.

Detailed description of the judgment process of the judgment unit 11 will be made below.

The judgment unit 11 selects a next process on the basis of the judgment in step S3 (step S4).

When to be larger than or equal to the threshold value which is the index of anonymity for all the groups (all groups preserve the anonymity) (Yes in step S4), the judgment unit 11 outputs the combination data which becomes a target of the judgment process as the anonymized combination data.

On the other hand, when there exists a group which is not larger than or equal to the threshold value (there exists a group which does not preserve the anonymity) (No in step S4), the judgment unit 11 instructs integration of the groups to the anonymization unit 12. The anonymization unit 12 integrates the groups which do not preserved the anonymity (step S5).

The group integration process of the anonymization unit 12 does have limitation in particular. For example, the anonymization unit 12 may focus on an optional quasi-identifier for groups which do not preserve the anonymity, and may abstract by integrating groups with the nearest distance of center-of-gravity distance on a data space.

After execution of the process in step S5, the judgment unit 11 judges whether or not the anonymity is preserved for any one of provision sources for group integrated by the anonymization unit 12, in the same way as step S4 (step S6). More concretely, the judgment unit 11 judges whether or not the number of records subtracted the number of records of the provision source is larger than or equal to the threshold value which is the index of the anonymity for each provision source information of the integrated group.

The judgment unit 11 selects a next process on the basis of the judgment result (step S7).

When all integrated groups are larger than or equal to the threshold value (Yes in step S7), the judgment unit 11 outputs the combination data which is a target for the judgment process as the anonymized combination data.

On the other hand, when a group in which the number of records is not larger than or equal to the threshold value exists (No in step S7), the judgment unit 11 instructs integration of groups to the anonymization unit 12 to perform. The anonymization unit 12 integrates the groups which does not preserved the anonymity again (step S5).

The judgment unit 11 and the anonymization unit 12 repeat steps S5 to S7 until all groups are larger than or equal to the threshold value.

Next, each step shown in FIG. 9 will be described by using a concrete example with reference to FIGS. 10 to 13. It is supposed that the anonymization device 10 is owned by Provider Z as premise. And, it is supposed that the provision sources of data are Hospital X and Hospital Y (refer to FIG. 1). Moreover, it is supposed that Provider Z acquires the data shown in FIG. 2 from Hospital X and the data shown in FIG. 3 from Hospital Y. That is, it is supposed that a quasi-identifier is information of “age”, and sensitive information is information of “disease code”. Moreover, it is supposed that the anonymity requires that a table of personal information is 2-anonymity.

In step S1 shown in FIG. 9, the judgment unit 11 acquires the combination data from the storage unit 13.

FIG. 10 is a diagram showing an example of the combination data which the storage unit 13 stores.

As shown in FIG. 10, the storage unit 13 stores personal information with information indicating the provision source of the data (provision source information). The judgment unit 11 acquires the combination data appended the provision source information.

In step S2 shown in FIG. 9, the judgment unit 11 divides the acquired combination data into plural groups for plurality records whose value of quasi-identifiers are same value as one group.

FIG. 11 is a diagram showing an example of the combination data divided into plural groups on the basis of value of a quasi-identifier.

As shown in FIG. 11, the combination data is divided into five groups whose “age”s are “20”, “21”, “22”, “23” and “24” respectively. In FIG. 11, it is indicated that anonymity is satisfied (OK) or is not satisfied (NG) for each group.

Here, the process for judging whether or not each group satisfies the anonymity for viewed from any one of provision sources of data will be described in detail.

First, the judgment unit 11 removes a record including one certain provision source information from records included in a certain group whose values of quasi-identifier are same. For example, the judgment unit 11 removes records of user 1, user 2 and user 3 whose provision source information are “Hospital X” from records whose “age”s are “20”. The judgment unit 11 judges the anonymity of the group whose “age”s are “20” after removing the three records. The number of records whose “age”s are “20” after removing the three records is one (a record of user 8). Accordingly, the judgment unit 11 judges that this group does not satisfy 2-anonymity (the number of records is not larger than or equal to two). That is, the judgment unit 11 judges that the group whose “age” is “20” does not preserve the anonymity.

The judgment unit 11 judges for all types of the provision source information for every group.

In the data shown in FIG. 11, the judgment unit 11 judges that groups whose “age”s are “21”, “22” and “23” do not preserve the anonymity.

On the other hand, for the group whose “age” is “24”, the number of records is two when removing the record of “Hospital X” or removing “Hospital Y”. Accordingly, the judgment unit 11 judges that the anonymity is preserved for any one of the provision source for the groups whose “age”s are “24”.

In this way, in this description, “2” which is the index of then anonymity becomes the threshold value.

When the judgment unit 11 judges that there exists the group whose number of records is not larger than or equal to two (there exists a group which does not preserved the anonymity) (No in step S4), it instructs integration of groups to the anonymization unit 12.

In step S5 shown in FIG. 9, the anonymization unit 12 integrates the groups in which the anonymity is not satisfied in accordance with the instruction from the judgment unit 11. For example, the anonymization unit 12 integrates the group whose “age” is “20” and the group whose “age” is “21”, and integrates the group whose “age” is “22” and the group whose “age” is “23” on the basis of closeness of distance on the data space. In addition, the anonymization unit 12 may integrate the data stored in the storage unit 13. Alternatively, the anonymization unit 12 may receive data of groups whose “age”s are “20” and “21” and groups whose “age”s are “22” and “23” from the judgment unit 11, and integrate the groups.

FIG. 12 is a diagram showing an example of data after anonymization process of the anonymization unit 12.

As shown in FIG. 12, the anonymization unit 12 abstracts values of “ages”, and integrates the groups. The data shown in FIG. 12 is the information targeted for repeated judgment by the judgment unit 11 in step S6 shown in FIG. 9.

In the case of the data shown in FIG. 12, in step S6 shown in FIG. 9, the judgment unit 11 judges that both group whose “age”s are “20-21” and the group whose “age” is “22-23” satisfies 2-anonymity even when removing records of “Hospital X” or records of “Hospital Y”. Accordingly, the judgment unit 11 outputs the combination data which is a target for current judgment as the anonymized combination data, (Yes in step S7).

FIG. 13 is a diagram showing an example of the anonymized combination data which the anonymization device 10 finally outputs.

As shown in FIG. 13, the anonymization device 10 (the judgment unit 11) removes the provision source information and the user ID (No.) from the combination data so that the provision sources are not leaked to outside and individual are not specified, and outputs the anonymized combination data.

As described above, the anonymization device 10 according to the first exemplary embodiment can preserve the anonymity of data for any one of data provisions sources.

A reason for this is as follows.

The judgment unit 11 removes the data which the provision source holds and judges whether or not the data which other provision source holds satisfies the anonymity for each provision source. Then, when not satisfying the anonymity, the anonymization unit 12 anonymizes data until satisfying the anonymity.

In addition, in this exemplary embodiment, although the anonymization process of the anonymization unit 12 is described as a bottom-up method, the anonymization unit 12 may anonymize by using a top-down process.

When anonymizing by the top-down process, the anonymization unit 12 does not integrate the data but divides the data.

Concretely, first, the anonymization unit 12 gathers the data into one group, decides a division point of the group afterward and divides the data into plural groups.

Description of an example of operation of the division is as follows.

First, the judgment unit 11 judges whether or not the number of records in case of removing data of each provision source is larger than or equal to a certain threshold value which is an index of anonymity for all divided groups for all types of provision source information. Then, when larger than or equal to the threshold value for all groups, the judgment unit 11 requests a division to the anonymization unit 12. The anonymization unit 12 performs anonymization of the top-down process (a division of the data). The judgment unit 11 repeats this operation as far as all groups satisfy the anonymity. Then, when at least one group which does not satisfy the anonymity exists after the anonymization of the anonymization unit 12, the judgment unit 11 cancels the last data division, that is, returns the data to groups of before the latest anonymization of the anonymization unit 12, and outputs the data as the anonymized combination data.

In addition, when the anonymization of the top-down process, the anonymization unit 12 may make, the median of each group of the combination data the division point, or may determine the division point by other method. For example, the anonymization unit 12 may determine the division points by considering an entropy amount. More concretely, the anonymization unit 12 may make a point whose deviation of provision sources (for example, Hospital X and Hospital Y) is small the division point for data belonging to divided group on the basis of entropy.

For example, the anonymization unit 12 may calculate entropy for divided group by using the following formula.

Entropy=Σ{−1×P(Class)×log(P(Class))}

Here, when “Class” is made “Hospital X” or “Hospital Y”, P (Class) becomes as follows, respectively.

P(Hospital X)=(the number of “Hospital X” in the group after division)/(the sum of the number of “Hospital X” and “Hospital Y” in the group after division)

P(Hospital Y)=(the number of “Hospital Y” in the group after division)/(the sum of the number of “Hospital X” and “Hospital Y” in the group after division).

That is, the anonymization unit 12 calculates entropy for group after division by using the following formula.

Entropy={−1×P(Hospital X)×log(P(Hospital X))}+{−1×P(Hospital Y)×log(P(Hospital Y))}

For example, the anonymization unit 12 calculates the above-mentioned entropy for two groups after the division at an appropriate division candidate point. In addition, the anonymization unit 12 may determine the division candidate point in accordance with a predetermined rule (algorithm), or may determine it in accordance with a well-known method. Then, the anonymization unit 12 may determine the division candidate point at which a value (S) adding entropies of the two groups becomes the maximum as the division point.

Largeness of the value S means that in the two groups, mixing conditions of data in the two groups (mixing conditions of data of “Hospital X” and data of “Hospital Y”) are large, and a deviation of data between the two groups is small.

And, the anonymization unit 12 may make a division candidate point including a group which takes the maximum entropy value among all division candidate points as the division point. A decision method for the division point using entropy is not limited to the above-mentioned method, but may be a different method.

And, in the description so far, the judgment unit 11 judges the anonymity by using k-anonymity as the index. However, the judgment unit 11 may judge not only the k-anonymity but also other index, for example, 1-diversity as the index. The 1-diversity is an index which requires 1 or more types of sensitive information in groups.

For example, the judgment unit 11 may judge whether or not the number of types of sensitive information included in the group is larger than or equal to the threshold value which is a predetermined index of 1-diversity for all groups for each type of provision source information when removing records including one type of provision source information from groups whose values of quasi-identifiers are the same.

As a concrete example, a case where 3-diversity is required in the combination data is considered.

For example, in data shown in FIG. 13, for groups whose “age” is “20-21” and “22-23”, types of “disease codes” which are sensitive information are five types (A, B, C, D and E) and four types (F, A, B and C), respectively. Accordingly, the groups whose “age” is “20-21” and “22-23” satisfy the 3-diversity. On the other hand, for the group whose “age” is “24”, types of “disease codes” are two types (C and D). Accordingly, the group whose “age” is “24” does not satisfy the 3-diversity. The judgment unit 11 judges that the 3-diversity is not satisfied, and instructs an anonymization to the anonymization unit 12.

The anonymization unit 12 anonymizes the data on the basis of the above-mentioned judgment results of the anonymity and the diversity of the judgment unit 11. In addition, the anonymization unit 12 may repeat the anonymization process. Alternatively, the judgment unit 11 may judge whether or not other index (for example, t-closeness) is satisfied. The t-closeness is the index which requires that, for two groups, a distance of distribution of sensitive data and a distance of distribution of all attributes are equal to or smaller than t.

And, in this exemplary embodiment, although an example in which each group includes both “Hospital X” and “Hospital Y” for the provision source information is described, the anonymization device 10 may generate a group of data of “Hospital X” or group of data of “Hospital Y”.

For example, in FIG. 12, the anonymization device 10 may make the group whose “age” is “22-23” the group whose provision sources are “Hospital Y” entirely. When data of group of “22-23” are records of Hospital Y entirely, other provision source (Hospital X) cannot reduce the number of the data in the group by using own data. Accordingly, the other provision source cannot specify individuals in the group. Thus, the anonymity to Hospital X does not lower.

### Second Exemplary Embodiment

Next, an anonymization device 20 according to a second exemplary embodiment of the present invention will be described.

The anonymization device 20 is different from the anonymization device 10 in the point that operates to preserve the anonymity even when plural provision sources conspire.

FIG. 14 is a block diagram showing an example of a configuration of the anonymization device 20 according to the second exemplary embodiment.

As shown in FIG. 14, the anonymization device 20 is different in the point including a judgment unit 21 in place of the judgment unit 11 and including a storage unit 23 in place of the storage unit 13 compared with the anonymization device 10 of the first exemplary embodiment. In addition, because the anonymization unit 12 operates as the first exemplary embodiment similarly, detailed description is omitted. And, in the description of this exemplary embodiment, it is supposed that 2-anonymity is required.

The storage unit 23 stores data associated with three or more types of provision source information. For example, the anonymization device 20 is provided data from Hospital W in addition to Hospital X and Hospital Y. Then, the storage unit 23 stores the combination data associated with three types of provision source information.

The judgment unit 21 gathers predetermined two or more types of provision source information as one type of provision source information for group in which three or more types of provision source information are included, and judges the anonymity for each type of the provision source information.

Next, operation of the anonymization device 20 according to the second exemplary embodiment of the present invention will be described with reference to FIG. 15.

FIG. 15 is a flowchart showing operation of the anonymization device 20 according to the second exemplary embodiment of the present invention. As shown in FIG. 15, the anonymization device 20 is different in the point executing step S8 in place of step S3 and step S9 in place of step S6 compared with the anonymization device 10. Because other steps are the same, detailed description is omitted.

In step S8, basically, the judgment unit 21 similarly operates as the judgment unit 11. The judgment unit 21 makes information combined predetermined two or more types of provision source information (for example, “Hospital Y” and “Hospital W”) one type of provision source information for the group in which three or more types of provision source information (for example, Hospital X, Hospital Y and Hospital W) are included. Then, the judgment unit 21 judges the anonymity for each type (“Hospital X” is one type, a combination of “Hospital Y” and “Hospital W” is one type) of the provision source information.

For example, when the reliability of Hospital Y and Hospital W is considered low, conspiracy of Hospital Y and Hospital W is assumed. Here, the conspiracy means that Hospital Y and Hospital W lower the anonymity by owning data jointly. Therefore, the judgment unit 21 judges whether or not the anonymity is preserved even when Hospital Y and Hospital W conspire and share the data which each holds.

In step S9, the judgment unit 21 judges the anonymity for the group which the judgment unit 21 integrates in step S5 by making predetermined two or more types of provision source information one type of provision source, just like in step S8.

Next, each step shown in FIG. 15 will be described using a concrete example with reference to FIGS. 16 to 19.

In step S1 shown in FIG. 15, the judgment unit 21 acquires data from the storage unit 23.

FIG. 16 is a diagram showing an example of the combination data which is appended provision source information of three types of “Hospital X”, “Hospital Y” and “Hospital W”.

As shown in FIG. 16, the storage unit 23 stores data of user 14 (the “age” is “21”, the “disease code” is “A”) and data of user 15 (the “age” is “22”, the “disease code” is “B”) acquired from Hospital Y in addition to the data which is stored in the storage unit 13 and shown in FIG. 10.

In step S2 shown in FIG. 15, the judgment unit 21 divides the data acquired from the storage unit 23 into plural groups on the basis of value of a quasi-identifier.

FIG. 17 is a diagram showing an example of a state where the data shown in FIG. 16 is divided into plural groups on the basis of value of a quasi-identifier.

As shown in FIG. 17, the combination data is divided into five groups whose “age”s are “20”, “21”, “22”, “23” and “24” respectively. In FIG. 17, whether the anonymity is satisfied (OK) or is not satisfied (NG) are indicated for each group when two or more hospitals conspire.

Here, a process in which the judgment unit 21 judges whether or not each group satisfies the anonymity for viewed from any one of provision sources of data when two or more hospitals conspire will be described in detail.

In this exemplary embodiment, the judgment unit 21 makes group in which the provision source information is included three or more types a judgment targets when conspiracy. And, it is supposed that the reliabilities of Hospital Y and Hospital W is low, and the judgment unit 21 judges whether or not the anonymity is satisfied by making “Hospital Y” and “Hospital W” one type of provision source.

In step S8 shown in FIG. 15, the judgment unit 21 judges the anonymity when making two types of provision source information (Hospital Y and Hospital W) one type of a provision source. However, in this exemplary embodiment, it is supposed that group in which the provision source information is included three or more types is a judgment targets when conspiracy.

Here, when confirming groups shown in FIG. 17, all groups are two types of provision sources. That is, the provision source information of each group is “Hospital X” and “Hospital Y” (group whose “age” is “20”), “Hospital Y” and “Hospital W” (group whose “age” is “21”), “Hospital X” and “Hospital W” (group whose “age” is “22”), “Hospital X” and “Hospital Y” (group whose “age” is “23”) and “Hospital X” and “Hospital Y” (group whose “age” is “24”). Accordingly, the judgment unit 21 does not perform judgment considering conspiracy. That is, the judgment unit 21 judges on the basis of one type of provision source information. The judgment result of the judgment unit 21 is that there is a group which does not satisfy the threshold value, as shown in FIG. 17 (No in step S4). Accordingly, the anonymization device 10 proceeds to step S5.

In step S5 shown in FIG. 15, the anonymization unit 12 integrates groups of “NG” in the data shown in FIG. 17.

FIG. 18 is a diagram showing an example of a state integrated the data shown in FIG. 17.

In the case shown in FIG. 18, the group whose “age” is “20-21” and the group whose “age” is “22-23” become targets for the judgment considering conspiracy because including provision source information of three types of “Hospital X”, “Hospital Y” and “Hospital W”.

In step S9 shown in FIG. 15, the judgment unit 21 judges the anonymity after removing record as making “Hospital Y” and “Hospital W” one type of the provision source from the group whose “age” is “20-21” and the group whose “age” is “22-23”, and then, judges the anonymity of each of these two groups. In this case, the group whose “age” is “20-21” remains three records of “Hospital X”, and the group whose “age” is “22-23” remains two records of “Hospital X”. That is, both groups satisfy the 2-anonymity. Therefore, the judgment unit 21 judges that all groups satisfy the anonymity. Accordingly, the judgment unit 21 outputs the combination data which becomes the judgment target as the anonymized combination data (Yes in step S7).

FIG. 19 is a diagram showing an example of the anonymized combination data which the anonymization device 20 finally outputs.

In addition, until here, though it is considered the case where the “Hospital Y” and “Hospital W” conspire, conspiracy patterns to be considered are not limited to this. For example, the judgment unit 21 may judge that the anonymity is preserved when all combinations of provision source information satisfy the anonymity. Concretely, for example, in the case of FIG. 18, the judgment unit 21 may judge anonymity by removing records for combination of “Hospital X” and “Hospital Y”, combination of “Hospital X” and “Hospital W” and combination of “Hospital Y” and “Hospital W” for each of groups whose “age”s are “20-21” and “22-23”. In this case, any one of groups does not satisfy 2-anonymity because a record of “Hospital W” is one when making “Hospital X” and “Hospital Y” or “Hospital X” and “Hospital W” one type. Accordingly, in the above-mentioned case, for the combination data, the groups are further integrated as shown in FIG. 20.

And, in description of this exemplary embodiment, the case where the provision source information in data targeted for the anonymization process are three types, and two types of provision source information become one type of provision source information. However, the present invention is not limited to this. The exemplary embodiment may make the provision source information for data of target of the anonymization process three or more types, and two or more types of provision source information one type of provision source information.

As described above, the anonymization device 20 according to the second exemplary embodiment can preserve the anonymity of data when plural provision sources providing the data conspire.

A reason for this is as follows.

Because the judgment unit 21 judges whether or not the anonymity is satisfied by making plural provision source information one type of provision source information. Then, it is because the judgment unit 21 instructs the anonymization to the anonymization unit 12 when the anonymity is not satisfied.

### Third Exemplary Embodiment

Next, an anonymization device 30 according to a third exemplary embodiment of the present invention will be described. The anonymization device 30 is different from the anonymization device 10 and the anonymization device 20 in the point that is set anonymization level, which are different in accordance with provision sources.

FIG. 21 is a block diagram showing an example of a configuration of the anonymization device 30 according to the third exemplary embodiment.

As shown in FIG. 21, the anonymization device 30 is different in the point including a setting unit 34 compared with the anonymization device 10 and the anonymization device 20. And, the anonymization device 30 is different in the point including a judgment unit 31 in place of the judgment unit 11 and the judgment unit 21. Because the storage unit 23 and the anonymization unit 12 are similar, detailed description is omitted. In addition, in the description of this exemplary embodiment, it is also supposed that 2-anonymity is required.

The setting unit 34 sets threshold values of anonymity levels which are different in accordance with each type of provision source information to the combination data which the storage unit 23 stores. The setting unit 34 may set, for example, the anonymity levels in accordance with the reliabilities of the provision sources. The setting unit 34 outputs the combination data set the anonymity levels which are different in accordance with the types of the provision source information to the judgment unit 31.

In this exemplary embodiment, as shown in FIG. 21, the setting unit 34 may receive setting instructions of anonymity levels in accordance with types of provision source information from user. And, the anonymization device 30 may start the anonymization process when the setting unit 34 receives the setting instruction.

The judgment unit 31 judges whether or not the number of records removed records including the same provision source information is larger than or equal to the threshold value (the index of anonymization) which is different in accordance with a type of provision source information.

Next, operation of the anonymization device 30 according to the third exemplary embodiment of the present invention will be described with reference to FIG. 22.

FIG. 22 is a flowchart showing operation of the anonymization device 30 according to the third exemplary embodiment of the present invention.

As shown in FIG. 22, the anonymization device 30 is different in the point that including step S10 compared with the operation of the anonymization device 10. And, operation of the anonymization device 30 is different in the point executing step S11 in place of step S3 and step S12 in place of step S6 compared with the operation of the anonymization device 10.

Because the other steps are similar, detailed description will be omitted appropriately.

In step S10, the setting unit 34 sets the threshold value of the anonymity level for each type of provision source information to the combination data which the storage unit 23 stores. The setting unit 34 may set a different anonymity level for each type of the provision source information, or may set a same threshold value of the anonymity level for plural types of the provision source information.

And, in step S11 and step S12, the judgment unit 11 judges whether or not the number of records removed the provision source information is larger than or equal to the threshold value of an anonymity level of the each type of the provision source information for each type of the provision source information for each group.

Next, individual steps of FIG. 22 will be concretely described by using an example with reference to FIGS. 23 to 27.

In this exemplary embodiment, it is supposed that the storage unit 23 stores the combination data shown in the FIG. 16 like the second exemplary embodiment.

In step S10 shown in FIG. 22, the setting unit 34 acquires the combination data from the storage unit 23. Then, the setting unit 34 sets the threshold value of the anonymity level for each type of the provision source information to the combination data which the storage unit 23 stores.

FIG. 23 is a diagram showing an example of the combination data which is set the threshold values of the anonymity levels for each type of the provision source information.

As shown in FIG. 23, for example, the setting unit 34 sets the anonymization level to “1” because the reliability of Hospital X is high, sets the anonymization level to “2” because the reliability of Hospital Y is ordinary, and sets the anonymization level to “3” because the reliability of Hospital W is low.

In step S2 shown in FIG. 22, the judgment unit 31 divides the data acquired from the storage unit 23 into plural groups on the basis of values of a quasi-identifier.

FIG. 24 is a diagram showing an example of a state where the data shown in FIG. 23 is divided into plural groups on the basis of a value of quasi-identifiers. As shown in FIG. 24, the combination data is divided into five groups whose “age”s are “20”, “21”, “22”, “23” and “24” respectively.

Here, a process in which the judgment unit 31 judges whether or not each group satisfies the anonymity level for each type of the provision source information for viewed from any one of the provision sources of data will be described in detail.

In step S11 shown in FIG. 22, the judgment unit 31 judges whether or not the number of records removed records whose provision source information are same is larger than or equal to the threshold level for each of types of the provision source information. In FIG. 24, it is indicated that the anonymity level of each type of the provision source information is satisfied (OK) or is not satisfied (NG) for each group.

For example, for the group whose “age” is “20”, the remainder is one of the record of “Hospital Y” when removed records of “Hospital X”. Hospital X has high reliability, and the “anonymization level” of “Hospital X” is “1”. Accordingly, the judgment unit 31 judges that the group whose “age” is “20” satisfies the anonymity. Alternatively, when removed “Hospital Y”, records of “Hospital X” remain three. The “anonymity level” of “Hospital Y” is “2”. Accordingly, the judgment unit 31 judges that the group whose “age” is “20” preserves the anonymity.

On the other hand, groups whose “age”s are “21” and “22” have low reliability, and include “Hospital W” whose anonymity level is “3”, respectively. Then, for each group, remained record is one when removing records of “Hospital W”. Accordingly, the judgment unit 31 judges that any one of groups whose “age”s are “21 and “22” does not satisfy the anonymity.

The judgment unit 31 judges for all groups similarly.

In step S5 shown in FIG. 22, the anonymization unit 12 integrates the groups of NG shown in FIG. 24.

FIG. 25 is a diagram showing an example of a state where the data shown in FIG. 24 is integrated.

First, the anonymization unit 12 of this exemplary embodiment integrates the groups whose “age”s are “21 and “22” among the groups of NG. For the group integrated the groups whose “age”s are “21 and “22” shown in FIG. 25, two records remain after removed records of “Hospital W”. The “anonymization level” of “Hospital W” is “3”. Accordingly, in step S12 shown in FIG. 22, the judgment unit 31 judges that the group of “21-22” does not satisfy the anonymity yet (No in step S7).

Accordingly, in step S5 shown in FIG. 22, the anonymization unit 12 integrates the group whose “age” is “21-22” and which is judged not to satisfy the anonymity again. The anonymization unit 12 integrates the group whose “age” is “21-22” and the group of “23”, which are groups of NG.

FIG. 26 is a diagram showing an example of a state where the data shown in FIG. 25 is integrated.

For the group of “21-23” which is integrated the groups whose “age”s are “21-22” and “23” shown in FIG. 26, five records remain after removed records of “Hospital W”. The “anonymization level” of “Hospital W” is “3”. Accordingly, in step S12 shown in FIG. 22, the judgment unit 31 judges that the group of “21-23” satisfies the anonymity (Yes in step S7).

FIG. 27 is a diagram showing an example of the anonymized combination data which the anonymization device 30 finally outputs.

As described above, the anonymization device 30 according to the third exemplary embodiment can preserve the anonymity of data in accordance with the reliability of the plural provision sources which provide the data.

A reason for this is as follows.

The setting unit 34 sets the threshold value of the anonymity level for each type of provision source information for the combination data which the storage unit 23 stores. Then, it is because the judgment unit 31 instructs anonymization of the anonymization unit 12 on the basis of the reliability of the provision sources.

In addition, in this exemplary embodiment, it is described on the assumption that the setting unit 34 sets the anonymity levels to the data which the storage unit 23 stores. However, the present invention is not limited to this. For example, the storage unit 23 may store the combination data which is set the anonymity levels in accordance with the provision sources in advance. In this case, the setting unit 34 is not needed. Alternatively, the judgment unit 31 may set the anonymity levels in accordance with the provision source before dividing into plural groups.

And, in the anonymization of the top-down process, when determined the division point by considering entropy, the anonymization unit 12 may use weighted entropy in accordance with the reliability.

For example, the anonymization unit 12 may calculate entropy for groups after dividing by using the following formula.

Entropy=Σ{−W_{Class}×P(Class)×log(P(Class))}

Here, exception the operation of multiplying W_{class}, may be the same function like the function shown in the first exemplary embodiment. And, the method for determining the division point on the basis of the value of the above-mentioned entropy may be the same as the method shown in the first exemplary embodiment. W_{class} is a weighting coefficient in accordance with the reliability of each “Class” (for example, each of Hospital X, Hospital Y and Hospital W). In the above-mentioned example, for example, “W_{class}” is “1” when “Class” is “Hospital X”, “W_{class}” is “2” when “Class” is “Hospital Y”, and “W_{class}” is “3” when “Class” is “Hospital W”.

### Fourth Exemplary Embodiment

Next, an anonymization device 40 according to a fourth exemplary embodiment of the present invention will be described.

The anonymization device 40 is different from the anonymization device 10, the anonymization device 20 and the anonymization device 30 in the point that is directly input data from outside to a judgment unit 41.

FIG. 28 is a block diagram showing an example of a configuration of the anonymization device 40 according to the fourth exemplary embodiment.

As shown in FIG. 28, the anonymization device 40 is different in the point not including storage unit compared with the anonymization device 10, the anonymization device 20 and the anonymization device 30.

The judgment unit 41 judges whether or not the anonymity of the data is preserved for viewed from any one of the provision sources having record which is a part of the combined data for the data which is combined with plural records acquired from the plural provision sources.

The anonymization unit 42 repeats the anonymization process of data on the basis of the judgment result of the anonymity of the judgment unit 41.

The judgment unit 41 outputs the combination data to outside as the anonymized combination data when it judges that the anonymity is preserved for the combination data for any one of the provision sources.

Next, operation of the anonymization device 40 according to the fourth exemplary embodiment will be described with reference to FIG. 29.

FIG. 29 is a flowchart showing operation of the anonymization device 40 according to the fourth exemplary embodiment of the present invention.

As shown in FIG. 29, the judgment unit 41 of the anonymization device 40 receives data from outside and generates the combination data (step S11). For example, the judgment unit 41 receives the data shown in FIG. 2 from Hospital X and the data shown in FIG. 3 from Hospital Y.

Subsequently, the anonymization device 40 processes like the anonymization device 10 according to the first exemplary embodiment.

As described above, the anonymization device 40 according to the fourth exemplary embodiment can preserve the anonymity of the data for any one of provision sources which provide data.

A reason for this is as follows.

The judgment unit 41 of the anonymization device 40 judges the anonymization like the anonymization device 10 of the first exemplary embodiment. Then, the judgment unit 41 instructs the anonymization of groups which do not satisfy the threshold value to the anonymization unit 12.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

FIG. 30 is a block diagram showing an example of a hardware configuration of the anonymization device 10 according to the first exemplary embodiment.

As shown in FIG. 30, each unit constituting the anonymization device 10 realizes a computer device including a CPU (Central Processing Unit) 1, a communication IF 2 (Communication Interface) for connecting with network, a memory 3, a storage device 4, an input device 5 and an output device 6. However, the configuration of the anonymization device 10 is not limited to the computer device shown in FIG. 30.

For example, the CPU 1 executes an operating system, and read out programs and data from a recording medium which is not shown in the figure and is attached to the storage device 4 into the memory 3. Then, the CPU 1 controls the whole anonymization device 10 in accordance with the read-out programs and executes various processes of the judgment unit 11 and the anonymization unit 12.

The communication IF 2 connects the anonymization device 10 with other device not shown in the figure via network. For example, the anonymization device 10 may receive data of Hospital X and Hospital Y from external devices not shown in the figures via the communication IF 2, and may store into the storage unit 13. Alternatively, the CPU 1 may download a computer program from an external computer which is not shown in the figure and is connected to a communication network via the communication IF 2.

The memory 3 is, for example, a D-RAM (dynamic random read memory), and temporarily stores programs and data.

The storage device 4 is, for example, an optical disc, a flexible disc, a magneto-optical disc, an external hard disk or a semiconductor memory, and stores a computer program with readable for the computer.

For example, the storage unit 13 may be realized by using the storage device 4.

The input device 5 is, for example, a mouse device, a keyboard and the like, and receives inputs from users.

The output device 6 is, for example, a display device, such as a display.

The anonymization devices 20, 30 and 40 according to the second to fourth exemplary embodiments may be configured by using the computer device including the CPU 1 and the storage device 4 storing programs.

In addition, the block diagrams (FIG. 8, FIG. 14, FIG. 21 and FIG. 28) used in each of the exemplary embodiments described before now do not show configurations of hardware units, but show blocks of functional units. These function blocks are realized by using an optional combination of hardware and software. And, a realization means of configuration units of the anonymization device 10 is not limited particularly. That is, the anonymization device 10 may be realized on the basis of a single device which is physically combined, or may be realized on the basis of plural devices which are two or more devices which are physically separated and are connected via a wired link or a wireless link.

A program according to the present invention may be a program which causes a computer to execute the each operation described in the above mentioned each exemplary embodiment.

This application is based upon and claims the benefit of priority from Japanese patent application No. 2012-032992, filed on Feb. 17, 2012, the disclosure of which is incorporated herein in its entirety by reference.

### DESCRIPTION OF SYMBOL

1 CPU
2 Communication IF
3 Memory
4 Storage device
5 Input unit
6 Output unit
10, 20, 30 and 40 Anonymization device
11, 21, 31 and 41 Judgment unit
12 and 42 Anonymization unit
13 and 23 Storage unit
34 Setting unit

1. An anonymization device comprising:
a judgment unit which judges whether or not anonymity of data is preserved to any one of providers which provide a record which is a part of the data for data which is combined with records acquired from plural providers; and
an anonymization unit which anonymizes the data on the basis of a judgment result of anonymity of said judgment unit.

2. The anonymization device according to claim 1, further comprising:
a storage unit which stores the data which is combination of records in which user attribute information which is attribute information relating to the user is associated with provider information which is information indicating a provider of the user attribute information; wherein
said judgment unit judge whether or not a number of records included a group is larger than or equal to a threshold which is an index of predetermined anonymity of all the groups for each type of provider information for data stored in said storage unit when a record including one type of the provider information is removed from groups whose values of quasi-identifier in the user attribute information are same, and judges whether or not the anonymity is preserved, on the basis of the judgment.

3. The anonymization device according to claim 2, wherein
said anonymization unit processes the anonymization using a bottom-up process until said judgment unit judges that the number of records is larger than or equal to the threshold value which is the index of the anonymity for all types of the provider information for all groups.

4. The anonymization device according to claim 2, wherein
said anonymization unit processes the anonymization using a top-down process when the judgment unit judges that the number of records is larger than or equal to the threshold value which is the index of the anonymity for all types of the provider information for all groups.

5. The anonymization device according to claim 2, wherein,
said judgment unit judges two or over types of the provider information for each type of the provider information as one type of provider in groups in which three or over types of the provider information is included when types of the provider information included in the data stored in said storage unit are three or over types.

6. The anonymization device according to claim 2, wherein
said judgment unit judges whether or not the number of records is larger than or equal to the threshold value which is the index of the anonymity by using a threshold value of each type of the provider information.

7. The anonymization device according to claim 2, wherein,
said judgment unit judges whether or not a number of types of sensitive information included in the group is larger than or equal to a threshold value which is a predetermined index of diversity for the all groups for each type of the provider information when a record including one type of the provider information is removed from the groups in which values of quasi-identifiers are same, and
said anonymization unit anonymizes the data on the basis of the judgment result of the diversity of said judgment unit.

8. The anonymization device according to claim 1, further comprising:
an output unit which outputs the anonymized data on the basis of the judgment result of said judgment unit.

9. An anonymization method comprising:
judging whether or not anonymity of data is preserved to any one of providers which provide a record which is a part of the data for data which is combined with records acquired from plural providers; and
anonymizing the data on the basis of the judgment result.

10. A computer readable medium embodying a program, said program causing an anonymization device to perform a method, said method comprising:
judging whether or not anonymity of data is preserved to any one of providers which provide a record which is a part of the data for data which is combined with records acquired from plural providers; and
anonymizing the data on the basis of the judgment result.

11. An anonymization device comprising:
judgment means for judging whether or not anonymity of data is preserved to any one of providers which provide a record which is a part of the data for data which is combined with records acquired from plural providers; and
anonymization means for anonymizing the data on the basis of a judgment result of anonymity of said judgment means.
